(19) United States
(12) Patent Application Publication
(10) Pub. No.: US 2023/0207302 A1
(43) Pub. Date: Jun. 29, 2023

(54) MASS SPECTROMETER

(71) Applicant: ASCEND DIAGNOSTICS LIMITED, Manchester (GB)

(72) Inventors: John ALLISON, Manchester (GB); Dimitris PAPANASTASIOU, Manchester (GB); Alexander LEKKAS, Manchester (GB)

(21) Appl. No.: 17/999,136

(22) PCT Filed: May 18, 2021
(86) PCT No.: PCT/GB2021/051184

§ 371 Date: Nov. 17, 2022

(30) Foreign Application Priority Data
May 18, 2020 (GB) 2007309.4

(51) Int. Cl. H01J 49/40; H01J 49/00; H01J 49/16; H01J 49/06

(52) U.S. Cl. CPC H01J 49/403; H01J 49/0081; H01J 49/164; H01J 49/068; H01J 49/067; H01J 49/0027

(57) ABSTRACT

A time-of-flight, TOF, mass spectrometer, MS, comprising: an ion source for supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>at a time t₀; a first set of electrodes, including a first electrode, and a second set of electrodes, including a first electrode and an Nth electrode, wherein the first set of electrodes and the second set of electrodes are mutually spaced apart by a gap therebetween; an ion detector for detecting the ions; a set of power supplies, including a first power supply, electrically coupled to the first set of electrodes and to the second set of electrodes; and a controller configured to control the set of power supplies to apply respective potentials to the first set of electrodes and the second set of electrodes; wherein the controller is configured to control the set of power supplies to: provide a first substantially field-free region between the ion source and the first set of electrodes to allow the group of ions to expand theretowards and/or therein, at the time t0; apply an extraction potential V_{extraction} to the first set of electrodes at a time t_{extraction}>t₀, to extract the expanded group of ions, while maintaining a second substantially field-free region beyond the first set of electrodes, in the gap between the first set of electrodes and the second set of electrodes; and optionally, change an acceleration potential V_{acceleration} applied to the second set of electrodes during a time period Δt=t_{off}−tₒₙ, wherein ton>t_{extraction}, to vary acceleration of the extracted group of ions based, at least in part, on respective mass-to-charge ratios.

### FIELD

The present invention relates to a time-of-flight, TOF, mass spectrometer, MS and a method of controlling a TOF MS.

### BACKGROUND TO THE INVENTION

Conventional time-of-flight, TOF, mass spectrometers, MS, coupled to laser desorption-ionization, LDI, sources typically employ two-stage acceleration configurations. A time delay is introduced between desorption-ionization and subsequent acceleration of ions towards a detector in what is also known as delayed pulsed extraction. This time-delay method is used to introduce a spatial spread and consequently, create a potential energy difference between ions having the same m/z ratio but having different initial velocities, therefore permitting isochronous arrival of these ions at the detector plane. This time-delay method may be considered an extension of an earlier method used in electron ionization TOF mass spectrometry for minimizing the adverse effects of turn-around time on mass resolving power. However, delayed pulsed extraction is strongly mass dependent and different time-delays or pulsed-extraction voltages are required to bring ions having different m/z ratios into focus at the detector. Hence, various time-dependent acceleration schemes for enhancing mass resolving power over extended m/z ranges and/or improving performance and/or utility of matrix-assisted LDI, MALDI, TOF MS, for example, have been described.

However, there remains a need to improve mass resolving power, for example over extended m/z ranges, for TOF MS, for example MALDI TOF MS.

### SUMMARY OF THE INVENTION

It is one aim of the present invention, amongst others, to provide a time-of-flight, TOF, mass spectrometer, MS and a method of controlling a TOF MS which at least partially obviates or mitigates at least some of the disadvantages of the prior art, whether identified herein or elsewhere. For instance, it is an aim of embodiments of the invention to provide a TOF MS having an improved mass resolving power, for example over an extended m/z range. For instance, it is an aim of embodiments of the invention to provide a method of controlling a TOF MS that provides enhanced time-focusing of ions having the same m/z ratio but having different initial velocities over an extended m/z range.

A first aspect provides a time-of-flight, TOF, mass spectrometer, MS, comprising:

an ion source for supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, at a time t₀;

a first set of electrodes, including a first electrode, and a second set of electrodes, including a first electrode and an Nth electrode, wherein the first set of electrodes and the second set of electrodes are mutually spaced apart by a gap therebetween;

an ion detector for detecting the ions;

a set of power supplies, including a first power supply, electrically coupled to the first set of electrodes and to the second set of electrodes; and

a controller configured to control the set of power supplies to apply respective potentials to the first set of electrodes and the second set of electrodes;

wherein the controller is configured to control the set of power supplies to:

provide a first substantially field-free region between the ion source and the first set of electrodes to allow the group of ions to expand theretowards and/or therein, at the time t₀;

apply an extraction potential V_{extraction} to the first set of electrodes at a time t_{extraction}>t₀, to extract the expanded group of ions, while maintaining a second substantially field-free region beyond the first set of electrodes, in the gap between the first set of electrodes and the second set of electrodes; and

optionally, change an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios.

A second aspect provides a method of controlling a time-of-flight, TOF, mass spectrometer, MS, the method comprising:

supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, from an ion source at a time t₀ and allowing the group of ions to expand towards and/or into a first substantially field-free region between the ion source and a first set of electrodes, including a first electrode;

applying an extraction potential V_{extraction} to the first set of electrodes at a time t_{extraction}>t₀, to extract the expanded group of ions, while maintaining a second substantially field-free region beyond the first set of electrodes, in a gap between the first set of electrodes and a second set of electrodes, including a first electrode and an Nth electrode, wherein the first set of electrodes and the second set of electrodes are mutually spaced apart by the gap;

changing an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios; and

detecting the ions.

A third aspect provides a computer comprising a processor and a memory configured to implement, at least in part, a method according to the second aspect.

A fourth aspect provides a computer program comprising instructions which, when executed by a computer comprising a processor and a memory, cause the computer to perform, at least in part, a method according to the second aspect.

A fifth aspect provides a non-transient computer-readable storage medium comprising instructions which, when executed by a computer comprising a processor and a memory, cause the computer to perform, at least in part, a method according to the second aspect.

### DETAILED DESCRIPTION OF THE INVENTION

According to the present invention there is provided a TOF MS, as set forth in the appended claims. Also provided is a method of controlling a TOF MS. Other features of the invention will be apparent from the dependent claims, and the description that follows.

TOF MS

The first aspect provides a time-of-flight, TOF, mass spectrometer, MS, comprising:

an ion source for supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, at a time t₀;

a first set of electrodes, including a first electrode, and a second set of electrodes, including a first electrode and an Nth electrode, wherein the first set of electrodes and the second set of electrodes are mutually spaced apart by a gap therebetween;

an ion detector for detecting the ions;

a set of power supplies, including a first power supply, electrically coupled to the first set of electrodes and to the second set of electrodes; and

a controller configured to control the set of power supplies to apply respective potentials to the first set of electrodes and the second set of electrodes;

wherein the controller is configured to control the set of power supplies to:

provide a first substantially field-free region between the ion source and the first set of electrodes to allow the group of ions to expand theretowards and/or therein, at the time t₀;

apply an extraction potential V_{extraction} to the first set of electrodes at a time t_{extraction}>t₀, to extract the expanded group of ions, while maintaining a second substantially field-free region beyond the first set of electrodes, in the gap between the first set of electrodes and the second set of electrodes; and

optionally, change an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios.

Hence, the ions initially (i.e. between the time t₀ and the time t_{extraction}>t₀) expand towards and/or into the first substantially field-free region, between the ion source and the first set of electrodes, during which equilibration of the ions takes place. At the time t_{extraction}>t₀, the extraction potential V_{extraction} is applied to the first set of electrodes, thereby extracting the expanded group of ions from the first substantially field-free region. Thus, the first set of electrodes defines a first ion acceleration stage, for accelerating the ions from the ion source theretowards and/or therethrough. Importantly, the extraction potential V_{extraction} is applied to the first set of electrodes while maintaining the second substantially field-free region beyond the first set of electrodes, in the gap between the first set of electrodes and the second set of electrodes. By maintaining the second substantially field-free region beyond the first set of electrodes while applying the extraction potential V_{extraction}, penetration of the electric field in due to the second set of electrodes is attenuated, minimised or even eliminated, thereby reducing, avoiding or even preventing otherwise prompt acceleration of the ions theretowards and/or diminishing or eliminating distortion of phase space during the time period t_{delay}=t_{extraction}−t₀ (i.e. a time delay), prior to the application of the extraction potential V_{extraction}. Additionally and/or alternatively, penetration of an electric field due to the ion source, for example a sample plate thereof, theretowards is also attenuated, minimised or even eliminated by the gap. Such prompt acceleration of the ions and/or distortion of the phase space otherwise further broadens a spatial distribution of the group of ions and/or a distribution of velocities of the group of ions. Hence, further broadening of the spatial distribution of the group of ions and/or the distribution of velocities of the group of ions is lessened, for example eliminated, by maintaining the second substantially field-free region beyond the first set of electrodes while applying the extraction potential V_{extraction}. Particularly, elimination of such prompt acceleration allows for a more precise correlation between initial ion position and initial velocity to be established at the onset of application of the extraction potential V_{extraction}, which has a strong effect on mass resolving power. Thus, by constraining the spatial distribution of the group of ions and/or the distribution of velocities of the group of ions, the mass resolution is thus improved. Subsequently, during the time period Δt=t_{off}−tₒₙ, wherein tₒₙ>t_{extraction}, the acceleration potential V_{acceleration} applied to the second set of electrodes is optionally changed to vary acceleration of the extracted group of ions based, at least in part, on respective mass-to-charge ratios (i.e. of the ions). Thus, the second set of electrodes defines a second ion acceleration stage for accelerating the ions from the first set of electrodes theretowards and/or therethrough, for example towards the ion detector. By changing the acceleration potential V_{acceleration} applied to the second set of electrodes during the time period Δt=t_{off}−tₒₙ to vary acceleration of the extracted group of ions based, at least in part, on respective mass-to-charge ratios, ions having relatively higher mass-to-charge ratios, for example, and traversing through the second set of electrodes at relatively later times are accelerated by a relatively changed, for example an increased, accelerating field due to the second set of electrodes compared with ions having relatively lower mass-to-charge ratios, for example, and traversing through the second set of electrodes at relatively earlier times. In this way, the relatively slower third ion, having the third mass-to-charge ratio m₃/z₃, is subject to an increased accelerating field, for example, compared with the relatively faster first ion having the first mass-to-charge ratio m₁/z₁. Particularly, ions having the same mass-to-charge ratio m/Z but different initial ion energies and hence velocities are similarly subject to different accelerating fields, thereby more effectively correcting for the initial ion energy spread and thus improving mass resolution. Particularly, in this way, time focusing of ions having the same mass-to-charge ratio m/Z but different initial ion energies is achieved.

In more detail, the inventors have identified a novel ion optical acceleration scheme for time-of-flight mass spectrometry of laser-produced ions from a solid target, for example, achieving enhanced time-focusing over an extended m/z range. The ion optical acceleration scheme involves a multiple stage acceleration configuration comprising a time-delay introduced between desorption-ionization, for example, and an extraction pulse applied across a first acceleration stage to transfer ions through a field-free gap into a second acceleration stage supplied with a time-dependent voltage ramp whereby heavier ions traversing the second acceleration stage at later times experience a quasi-linear, most preferably a linear, increase in the magnitude of the accelerating field, for example.

The ion optical acceleration scheme provides advantages over conventional acceleration configurations, as demonstrated using a new set of analytical equations, numerical analysis tools such as simulations and experimental measurements.

The prevention of electric field penetration, for example axial and/or radial field penetration, of the second accelerating stage into the first pulsed extraction stage, to eliminate prompt acceleration of ions and distortion of phase space during the time-delay and prior to the application of the extraction pulse, is accomplished by introducing a short intermediate field-free gap. Elimination of the prompt acceleration effect allows for a more precise correlation between initial ion position and initial velocity to be established at the onset of the extraction voltage pulse, which has a strong effect on mass resolving power. The short intermediate field-free gap also allows for using electrodes with increased size apertures, enhancing transmission of heavier ions with considerably wider initial kinetic energy spreads, while also minimizing the amount of material deposited on critical surfaces, especially those in the desorption-ionization region, extending the operational lifetime of the system.

Furthermore, the short intermediate field-free gap created between the two consecutive electrodes (i.e. between the first set of electrodes and the second set of electrodes) decouples the application of the extraction voltage pulse (i.e. the extraction potential V_{extraction}) to the first set of electrodes and the application of the high voltage ramp (i.e. the acceleration potential V_{acceleration}) to the second set of electrodes. By decoupling the application of these potentials such that their application is mutually independent, a complexity of analogue electronics design, for example, is considerably reduced. For example, the extraction pulse is applied to the entrance electrode of the field-free gap while the voltage ramp is applied independently to the electrode defining the exit end of the field-free gap while both the extraction pulse and the voltage ramp may be produced with high integrity and/or stability. In other words, respective reproducibilities of extraction pulses and voltage ramps may be improved, thereby reducing mass resolution aberrations otherwise due to pulse to pulse and/or ramp to ramp variations.

In addition and in further contrast to conventional ion optical schemes where a post acceleration stage is be coupled to a two-stage pulsed extraction scheme through an elongated field free region, for example, a preferred example comprises a single stage pulsed-extraction region closely coupled with a consecutive field-free gap, which is capable of reducing the time difference between ions over an extended m/z range being transferred into the second acceleration stage where the ramp potential can be applied more effectively to correct for the initial energy spread.

The inventors have produced a new set of analytical equations, as detailed below, to optimize the new acceleration scheme numerically and further validate results by ion optical simulations using linear and quasi-linear ramped potentials created experimentally.

Delayed Extraction

Conventionally, delayed extraction is used for TOF MS to improve mass resolution. A plume (also known as a packer or a group) of ions is generated, for example by pulsed laser desorption/ionization from a flat surface of target plate or pulsed electron ionization or resonance enhanced multiphoton ionization in a narrow space between two plates of the ion extraction system, during a short pulse of typically a few nanoseconds. Once generated, the plume is allowed to expand for about 50 ns to 100 ns before extraction is initiated. Otherwise, the ions are extracted through the ‘dense’ cloud of non-ionised material that is also generated, that will scatter the ions of interest and thus degrade resolution. Ion equilibration in the plasma plume occurs within about 100 nanoseconds, after which most ions (irrespective of their mass) initially move with an average velocity, having a distribution, in the direction of extraction. To compensate for this distribution in average velocity and thereby improve mass resolution, extraction of the ions towards the flight tube is delayed by typically a few hundred nanoseconds to a few microseconds, typically 200 ns to 500 ns. This is referred to as ‘time-lag focusing’ for ionization of atoms or molecules by resonance enhanced multiphoton ionization or by electron impact ionization in a rarefied gas and as ‘delayed extraction’ for ions produced generally by laser desorption/ionization, for example of molecules adsorbed on flat surfaces or microcrystals placed on conductive flat surface. The extraction delay can produce TOF compensation for ion energy spread and hence improve mass resolution.

Delayed extraction is conventionally used with MALDI or laser desorption/ionization (LDI) ion sources where the ions to be analyzed are produced in an expanding plume moving from the sample plate with a high speed (400-1000 m/s). Since the thickness of the ion packets arriving at the detector is important to mass resolution, on first inspection it can appear counter-intuitive to allow the ion plume to further expand before extraction. Delayed extraction is more of a compensation for the initial momentum of the ions: it provides the same arrival times at the detector for ions with the same mass-to-charge ratios but with different initial velocities.

In delayed extraction of ions produced in vacuum, such as in LDI or MALDI sources for example at a few milliTorr, the ions having relatively lower forward momentum (i.e. in the direction of extraction) are initially accelerated at a relatively higher potential since they are relatively further from the extraction plate when the accelerating extraction field is turned on. Conversely, those ions having relatively greater forward momentum are initially accelerated at a relatively lower potential since they are relatively closer to the extraction plate. Hence, at the exit from the acceleration region, those ions, having a specific m/z ratio, having initially relatively lower forward momentum at the back of the plume are accelerated to greater velocities than those ions, having the same specific m/z ratio, having initially relatively higher forward momentum at the front of the plume. Thus, after delayed extraction, the ions, having the same specific m/z ratio, that exit the ion source relatively earlier have relatively lower velocities in the direction of the acceleration compared with those ions, having the specific m/z ratio, that exit the ion source relatively later. If ion source parameters, particularly the time delay, are properly adjusted, these relatively faster ions catch up with these relatively slower ions at the ion detector, which thus detects relatively more simultaneous arrival of the ions having the same specific m/z ratio. That is, ions having the same m/z ratio effectively drift through the flight tube to the detector in the same time, despite having different initial forward momentum. In its way, the delayed application of the acceleration field acts as a one-dimensional time-of-flight focusing element.

Nevertheless, delayed extraction requires proper adjustment of the ion source parameters, particularly the time delay, to produce TOF compensation for ion energy spread and hence improve mass resolution. Thus, conventional implementations of delayed extraction are still combined with additional methods of improving mass resolution. For example, orthogonal acceleration, OA, TOF MS effectively reduces the average velocity distribution by collisional cooling and extracting the cooled ions orthogonally from the cooled ion beam. For example, reflectron TOF MS uses a constant electrostatic field to reflect the ions back towards the ion detector: more energetic ions, having a specific m/z ratio, penetrate relatively deeper into the reflectron and thus take a relatively longer path to the ion detector than less energetic ions such that the ion detector thus detects relatively more simultaneous arrival of the ions having the same specific m/z ratio. Thus, complexity, cost and size of the TOF MS is increased by these additional methods. Hence, there remains a need to improve delayed extraction that improves mass resolution, that is more robust to adjustment of the ion source parameters, particularly the time delay, and/or that does not require combination with additional methods of improving mass resolution. Particularly, there remains a need to improve mass resolution of linear TOF MS, for example for an extended m/z range of interest.

Theory

A set of analytical equations is developed below to describe ion motion in accelerating electric fields with linearly varying voltage ramps. A force exerted on a charged particle, expressed as a rate of change in momentum, dP/dt, is proportional to the product of charge q of the charged particle and an electric field intensity E of the accelerating electric field. A voltage V₀ applied initially to an entrance electrode of the second stage of acceleration increases over time at a rate r, measured in units Vs⁻¹, to a final value V. The thus ramped electric field is established across the second accelerating region having a length d, as defined by Equations (1)-(3):

$$\frac{d P}{d t} = q E ⇒ {\int }_{o}^{t} \frac{d P}{d t} = {\int }_{o}^{t} qE \qquad Equation ( 1 )$$

$$V = {V}_{0} + r t \qquad Equation ( 2 )$$

$$E = \frac{V}{d} \qquad Equation ( 3 )$$

Substituting and solving for the time dependent momentum gives Equation (4):

p(t)−p(0)=∫ₒ^{t}q(V₀+rt)dt

Integrating and rearranging Equation (4) gives Equation (5):

$$p ( t ) = \frac{q}{d} ( {V}_{0} t + \frac{r {t}^{2}}{2} ) + p ( 0 )$$

Equation (5) may be expressed in terms of potential energy U, where m is the mass of the charged particle, as shown by Equation (6):

$$U ( t ) = \frac{q}{m d} ( {V}_{0} t + \frac{r {t}^{2}}{2} ) + U ( 0 )$$

The equation of ion motion of the charged particle may be obtained by integration of Equation (6), giving Equation (7):

$${\int }_{o}^{t} U ( t ) d t = \frac{q}{m d} {\int }_{o}^{t} ( ( {V}_{0} t + \frac{r {t}^{2}}{2} ) + U ( 0 ) ) d t$$

Expressing distance as a function of time x(t) and substituting into Equation (7) gives Equation (8):

$$x ( t ) = \frac{q}{md} \frac{{rt}^{3}}{6} + \frac{q}{md} \frac{{V}_{0} {t}^{2}}{2} + U ( 0 ) t$$

where U(0) is the ion potential energy (of the charged particle) at the entrance of the second accelerating field, d. The equation of ion motion is then used to optimize the three-stage acceleration configuration with the field-free gap in-between the first pulsed extraction region and the second acceleration region supplied with the voltage ramp.

TOF MS

The first aspect provides the TOF MS. In one example, the TOF MS comprises and/or is a linear TOF MS, for example having a linear flight tube arranged between the second set of electrodes and the detector. In one example, the TOF MS comprises and/or is a reflectron TOF MS, for example having a reflectron arranged between the second set of electrodes and the detector.

Ion Source

The TOF MS comprises the ion source. In one example, the ion source comprises and/or is a pulsed ion source, for example a pulsed laser ion source. In one example, the ion source comprises and/or is a LDI ion source, preferably a pulsed LDI ion source, for example a MALDI ion source or a surface assisted laser desorption/ionization SALDI, source. In one example, the ion source comprises and/or is laser ablation electrospray ionization, LAESI, source, a pulsed electron ionization and/or a resonance enhanced multiphoton ionization source. In one example, the pulsed ion source has a pulse duration in a range from 0.1 ns to 50 ns, preferably in a range from 0.5 ns to 20 ns, more preferably in a range from 1 ns to 5 ns. Generally, reducing the pulse duration is preferable since spread of start times is reduced, as understood by the skilled person, while increasing pulse homogeneity and/or reproducibility further improves mass resolution. In one example, the pulsed laser ion source has a wavelength in a range from 266 to 355 nm (i.e. ultraviolet).

In one example, the ion source comprises, in use, a sample plate, for example a LDI sample plate such as a MALDI sample plate or a laser ablation sample plate. It should be understood that generally, a sample plate is inserted into the TOF MS for mass spectrometry of a sample thereon. That is, sample plate is not only permanently installed in the TOF MS.

The ion source is for supplying (i.e. in use) the group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, at a time t₀. In use, the group of ions forms a plume, for example upon MALDI of a sample. It should be understood that supplying the group of ions at the time t₀ is not instantaneous but instead during a relatively short duration, for example during the pulse duration, as described above. However, this relatively short duration is short compared with durations for ion equilibration, a time period t_{delay}=t_{extraction}−t₀, the time period Δt=t_{off}−tₒₙ during which the acceleration potential V_{acceleration} applied to the second set of electrodes is optionally changed and/or a flight time of the ions.

First Set of Electrodes

The TOF MS comprises the first set of electrodes, including the first electrode. The first set of electrodes defines the first ion acceleration stage, as described above, for accelerating the ions from the ion source, for example from a sample plate, theretowards and/or therethrough. The first ion acceleration stage may be thus defined between the sample plate (i.e. of the ion source, the ion source) and the first set of electrodes. It should be understood that each electrode, for example the first electrode, comprises a respective ion aperture (also known as a passageway) therethrough for passage of ions therethrough. It should be understood that these respective ion apertures are linearly aligned, for example defining a first axis therethrough. In one example, the first electrode comprises a plate, having an ion aperture therethrough.

In one example, the first set of electrodes includes M electrodes, including the first electrode, wherein M is a natural number greater than or equal to 1, for example 1, 2, 3, 4, 5, 6, 7, 8, 9, 10 or more, wherein the M electrodes are mutually spaced apart, preferably mutually equispaced apart. By increasing M, a homogeneity and/or a linearity of the first ion acceleration stage may be improved. Conversely, by decreasing M, a complexity and/or a size of the first ion acceleration stage may be reduced. In one example, the first set of electrodes consists of the first electrode i.e. M is equal to 1. In this way, the first electrode thus provides one end of the first substantially field-free region, defines the first ion acceleration stage and provides one end of the second substantially field-free region therebeyond, noting that the first substantially field-free region, the first ion acceleration stage and the second substantially field-free region are provided at different times. That is, by controlling potentials applied to just the first electrode, the first electrode may be provide, at least in part, the first and second substantially field-free regions and the first ion acceleration stage. In this way, a complexity and/or a size of the first ion acceleration stage may be reduced. In one example, the first electrode comprises a plate or a ring, having an ion aperture therethrough, having a width in a range from 10 μm to 2 mm, preferably in a range from 100 μm to 1 mm. In one example, the first set of electrodes is provided, for example by metallization, in the bore of an electrically insulating tube or a pipe, having a ion aperture (i.e. the bore) therethrough, the first electrode having a width in a range from 10 μm to 2 mm, preferably in a range from 100 μm to 1 mm. The M electrodes may be as described with respect to the first electrode.

In one example, a diameter D of the first electrode and/or of the Mth electrode of the first set of electrodes is at least twice a length g of the gap, wherein D≥2 g and preferably D≥3 g. In this way, radial field penetration from the second set of electrodes into the second substantially field-free region is reduced.

Second Set of Electrodes

The TOF MS comprises the second set of electrodes, including the first electrode and the Nth electrode. The second set of electrodes defines the second ion acceleration stage for accelerating the ions from the first set of electrodes theretowards and/or therethrough. It should be understood that the first electrode and the Nth electrode of the second set of electrodes are mutually spaced apart and arranged at mutually opposed ends of the second set of electrodes. It should be understood that each electrode, for example the first electrode and the Nth electrode, comprises a respective ion aperture (also known as an aperture) therethrough for passage of ions therethrough. It should be understood that these respective ion apertures are linearly aligned, for example defining a second axis therethrough. In one example, the first axis and the second axis are coaxial.

In one example, the second set of electrodes includes N electrodes, including the first electrode and the Nth electrode, wherein N is a natural number greater than or equal to 2, for example 2, 3, 4, 5, 6, 7, 8, 9, 10 or more, wherein the N electrodes are mutually spaced apart, preferably mutually equispaced apart. By increasing N, a homogeneity and/or a linearity of the first ion acceleration stage may be improved. In one example, the first electrode comprises a plate or a ring, having a ion aperture therethrough, having a width in a range from 10 μm to 2 mm, preferably in a range from 100 μm to 1 mm. In one example, the second set of electrodes is provided, for example by metallization, in the bore of an electrically insulating tube or a pipe, having an ion aperture (i.e. the bore) therethrough, the first electrode having a width in a range from 10 μm to 2 mm, preferably in a range from 100 μm to 1 mm. The N electrodes may be as described with respect to the first electrode.

In one example, a diameter D of the first electrode of the second set of electrodes is at least twice a length g of the gap, wherein D≥2 g and preferably D≥3 g. In this way, radial field penetration from the second set of electrodes into the second substantially field-free region is reduced.

Gap

The first set of electrodes and the second set of electrodes are mutually spaced apart by the gap therebetween. It should be understood that the gap is thus a void comprising at most a gas preferably at a relatively low pressure, for example at a high vacuum for example at an operating pressure of at most 5×10⁻⁵ mbar, preferably of at most 5×10⁻⁶ mbar, through which the ions traverse from the first set of electrodes to the second set of electrodes i.e. from the first stage of acceleration to the second stage of acceleration. In one example, the first set of electrodes includes M electrodes and the Mth electrode of the first set of electrodes and the first electrode of the second set of electrodes are mutually spaced apart by the gap therebetween. That is, the Mth electrode of the first set of electrodes and the first electrode of the second set of electrodes may be adjacent. In one example, the first set of electrodes consists of the first electrode and the first electrode of the first set of electrodes and the first electrode of the second set of electrodes are mutually spaced apart by the gap therebetween. That is, the respective first electrodes of the first set of electrodes and the second set of electrodes may be adjacent. In one example, the gap is along an ion path defined from the ion source to the detector via the first set of electrodes and the second set of electrodes. In one example, the gap is a linear gap.

In one example, a length g (also known as axial extent) of the gap between the first set of electrodes and the second set of electrodes is at least a diameter d of an ion aperture in the first set of electrodes, for example in the first electrode or the Mth electrode thereof, or the second set of electrodes, for example in the first electrode thereof. That is, in one example, g≥d, preferably g≥3/2 d, more preferably g≥2 d. In this way, electric field penetration, for example axial field penetration, of the second stage of acceleration into the first stage of acceleration may be reduced. Increasing the length g to greater than, for example 5d does not further reduce electric field penetration significantly while increases path length. In one example, g≤20 d, preferably g≤10 d, more preferably g≤5 d.

Ion Detector

The TOF MS comprises the ion detector for detecting the ions. In one example, the ion detector comprises and/or is a microchannel plate, MCP, detector and/or a fast secondary emission multiplier, SEM, for example having a flat first converter plate (dynode) is flat. Other ion detectors are known. An electrical signal from the ion detector due, at least in part, to the detected ions is typically measured using a time-to-digital converter, TDC, or a fast analogue-to-digital converter, ADC.

Set of Power Supplies

The TOF MS comprises the set of power supplies, including the first power supply, electrically coupled to the first set of electrodes and to the second set of electrodes. In one example, the first power supply comprises and/or is a high-voltage, HV, power supply. Generally, each power supply of the set power supplies may be as described with respect first power supply. Suitable power supplies for applying the respective potentials to the first set of electrodes and to the second set of electrodes are known. Suitable power supplies are available from Spellman High Voltage Electronics Corporation (Hauppauge, N.Y., USA), Matsusada Precision Inc. (Shiga, Japan) and Applied Kilovolts Ltd. (Worthing, UK). In one example, the first (extraction pulse) power supply comprises and/or is a 1 kV to 5 kV, for example a 2.5 kV power supply unit (PSU), having a stability of <1000 ppm. In one example, the second (ramp pulse) power supply comprises and/or is a 5 kV to 20 kV, for example a 10 kV PSU having a stability of <100 ppm. In one example, the third (source) power supply is a 5 kV to 20 kV, for example a 10 kV PSU having a stability of <100 ppm. In one example, a fourth (ramp bias) power supply, electrically coupled, for example only electrically coupled, to the second set of electrodes, comprises and/or is a 5 kV to 20 kV, for example a 10 kV PSU having a stability of <100 ppm. Reversible versions of these power supplier may be employed to enable switching between the analysis of positive and negative ions.

In one example, the set of power supplies includes the first power supply electrically coupled, for example only electrically coupled, to the first set of electrodes and a second power supply electrically coupled, for example only electrically coupled, to the second set of electrodes. In this way, the respective potentials applied to the first set of electrodes and to the second set of electrodes may be independently supplied and/or controlled.

In one example, the ion source comprises, in use, a sample plate and the set of power supplies includes a third power supply electrically coupled, for example only electrically coupled, in use to the sample plate. In this way respective potentials applied to the sample plate and to the first set of electrodes and/or to the second set of electrodes may be independently supplied and/or controlled.

In one preferred example, the ion source comprises, in use, a sample plate and the set of power supplies includes the first power supply electrically coupled, for example only electrically coupled, to the first set of electrodes, a second power supply electrically coupled, for example only electrically coupled, to the second set of electrodes and a third power supply electrically coupled, for example only electrically coupled, in use to the sample plate.

Controller

The TOF MS comprises the controller configured to control the set of power supplies to apply the respective potentials to the first set of electrodes and the second set of electrodes. Typically, controllers for MS are implemented using a combination of electronics, firmware and/or software, for example using a computer comprising a processor and a memory, as understood by the skilled person.

In one example, the controller is configured to control the ion source, for example to supply the group of ions at the time t₀. For example, for a MALDI ion source, the controller may be controlled to fire a laser pulse at the time t₀.

First Substantially Field-Free Region

The controller is configured to control the set of power supplies to provide the first substantially field-free region between the ion source and the first set of electrodes to allow the group of ions to expand theretowards and/or therein, at the time t₀. The time t₀ is as described previously.

More generally, in one example, the controller is configured to control the set of power supplies to provide the first substantially field-free region between the ion source and the first set of electrodes for a time period t_{delay}=t_{extraction}−t₀. That is, for the time period t_{delay}=t_{extraction}−t₀ before the extraction potential V_{extraction} is applied to the first set of electrodes at the time t_{extraction}>t₀, the first substantially field-free region between the ion source and the first set of electrodes is provided. In one example, the time period t_{delay}=t_{extraction}−t₀ is in a range from 100 ns to 10 μs, preferably in a range from 500 ns to 2 μs.

It should be understood that the first substantially field-free region comprises at most a relatively low electric field, for example compared with that electric field due to the extraction potential V_{extraction}. In one example, the first substantially field-free region comprises an electric field in a range from 0 Vmm⁻¹ to 50 Vmm⁻¹, preferably in a range from 1 Vmm⁻¹ to 25 Vmm⁻¹, more preferably in a range from 2 Vmm⁻¹ to 10 Vmm⁻¹.

In one example, the controller is configured to control the set of power supplies to provide the first substantially field-free region between the ion source and the first set of electrodes by applying the same potential to the first set of electrodes as the potential applied to a sample plate of the ion source, for example.

In one example, the controller is configured to control the set of power supplies to provide the first substantially field-free region between the ion source and the first set of electrodes by applying a static voltage V_{PE}=V_{B} to the first set of electrodes, wherein the voltage V_{B} is applied to the sample plate of the ion source.

The first ion and the third ion may define a mass-to-charge range of interest. For example, the first ion may define the lower bound and the third ion may define the upper bound of the mass-to-charge range of interest. In one example, the controller is configured to control the set of power supplies to change the acceleration potential V_{acceleration} applied to the second set of electrodes from the time tₒₙ, when the first ion, the second ion and the third ion are between the first electrode and the Nth electrode of the second set of electrodes, for example when the first ion is relatively proximal the Nth electrode and the third ion is relatively proximal the first electrode. That is, the time tₒₙ is no earlier than or coincides with the third ion having travelled through the gap between the first set of electrodes and the second set of electrodes. In other words, all ions in the mass-to-charge range of interest are in the second stage of acceleration before the acceleration potential V_{acceleration} is changed.

Extraction

The controller is configured to control the set of power supplies to apply the extraction potential V_{extraction} to the first set of electrodes at the time t_{extraction}>t₀, to extract the expanded group of ions. That is, controller is configured to control the set of power supplies to apply the extraction potential V_{extraction} after providing the first substantially field-free region. In other words, expansion of the ions into the first substantially field-free region and extraction of the ions therefrom are successive, for example immediately successive, while not overlapping in time. It should be understood that the extraction potential V_{extraction} comprises and/or is a pulse i.e. an extraction potential pulse. In one example, the extraction potential V_{extraction} is applied for a pulse duration t_{extraction_duration} in a range from 0.1 μs to 50 μs, preferably in a range from 0.5 μs to 20 μs, more preferably in a range from 2 μs to 10 μs. Generally, the duration of the extraction potential pulse is long enough so that all the ions of interest have left the extraction region. Hence, the pulse duration depends, at least in part, on a given ion optical configuration and/or a mass-charge range of interest, as described below in more detail. In one example, tₒₙ≤(t_{extraction}+t_{extraction_duration})≤t_{off}. In one example, the extraction potential V_{extraction} is in a range from 0.1 kV to 10 kV, preferably in a range from 0.5 kV to 5 kV.

Second Substantially Field-Free Region

The controller is configured to control the set of power supplies to apply the extraction potential V_{extraction} to the first set of electrodes at the time t_{extraction}>t₀, while maintaining the second substantially field-free region beyond the first set of electrodes, in the gap between the first set of electrodes and the second set of electrodes. That is, the second substantially field-free region is in the gap between the first set of electrodes and the second set of electrodes and the second substantially field-free region is maintained whilst the extraction potential V_{extraction} is applied to the first set of electrodes. More generally, in one example, the controller is configured to control the set of power supplies to provide the second substantially field-free region beyond the first set of electrodes, in the gap between the first set of electrodes and the second set of electrodes, during a duration from the time t_{extraction} to the time tₒₙ>t_{extraction}.

It should be understood that the second substantially field-free region comprises at most a relatively low electric field, for example compared with that electric field due to the extraction potential V_{extraction} and/or the acceleration potential V_{acceleration}. In one example, the second substantially field-free region comprises an electric field in a range from 0 Vmm⁻¹ to 50 Vmm⁻¹, preferably in a range from 1 Vmm⁻¹ to 25 Vmm⁻¹, more preferably in a range from 2 Vmm⁻¹ to 10 Vmm⁻¹.

In one example, the controller is configured to control the set of power supplies to maintain the second substantially field-free region beyond the first set of electrodes, in the gap between the first set of electrodes and the second set of electrodes, to at most 1% of the extraction potential V_{extraction}/mm.

The field free gap or region (i.e. the second substantially field-free region) primarily prevents electric field penetration of the second accelerating stage into the first pulsed extraction stage. This eliminates prompt acceleration of ions and distortion of phase space during the time-delay and prior to the application of the extraction pulse. Elimination of the prompt acceleration effect allows for a more precise correlation between initial ion position and initial velocity to be established at the onset of the extraction voltage pulse, which has a strong effect on mass resolving power.

The field free gap also decouples the application of the extraction voltage pulse across the first extraction stage and the application of the high voltage dynamic ramp across the second acceleration stage. The extraction pulse is applied to the electrode defining the entrance of the field-free gap while the voltage ramp is applied independently to the electrode defining the exit end of the field-free gap. Decoupling the application of the two signals allows them to be produced with high integrity and stability. For example, HV pulsing induces different DC offsets (depending on duty cycle and amplitude of the pulse) on the entrance (pulsed) electrode and exit (ramp) electrode that can only be effectively tuned out by adjusting the bias power supplies independently, which can only be done by decoupling the application of the extraction and ramp pulses as described herein.

Effective field free gaps can be formed by metal tubes or thick electrodes, but these approaches do not allow for the decoupling of the pulsed and ramped voltages applied at the entrance and exit of the field free gap respectively. The field free gap is preferably formed by two apertured planar electrodes that enable the application of different HV pulses to each electrode.

The field free gap could also be formed in a volume, typically bounded, for example, by a metal cylinder, designed to allow a gas pressure somewhat above the source high vacuum, e.g. a collision cell. However, the gas pressure within the cell should be low enough, typically <5×10⁻⁶ kPa, to not significantly scatter the ion beam as it passes through the cell and degrade the resolution improvement achieved by the implementation of the field-free gap. Again, forming the field free gap in this way would not allow for the decoupling of the pulsed and ramped voltages applied at either end of the field free region.

Due to the finite outer diameter of electrodes and apertures, radial and/or axial field penetration will give rise to residual electric fields within the field free gap. However, the dimensions of the field free gap can be defined to minimize the residual field within this region. The residual field that can be tolerated in the field-free gap is ultimately determined by the resulting distortion of phase space in the extraction region and its effect on resolving power. Electric fields of <10 Vmm⁻¹ in the field free gap have been found not to significantly distort the phase space in the extraction region with an extraction potential of 1 kV, for example, applied across the extraction region.

The length of the field free gap required is defined, at least in part, by the extent of field penetration from second acceleration to first acceleration stages which itself depends on the potentials applied to the electrodes bounding the field free gap and the size of the apertures in the electrodes, but typically the axial extent g of the gap (i.e. the length g of the gap between the first set of electrodes and the second set of electrodes) should be greater than or equal to the aperture diameter d, i.e. g≥d and preferably g≥2 d to minimize the effects of axial field penetration.

The diameter D of the electrodes forming the field free region (i.e. the outer diameter or dimension of the Mth electrode of the first set of electrodes and/or the first electrode of the second set of electrodes) must be large enough, with respect to the length g of the gap, to prevent radial field penetration into the field free region. Typically, D≥2 g has been found to prevent radial field penetration while preferably D≥3 g to prevent significant radial field penetration.

In one example, the controller is configured to control the set of power supplies to provide a substantially linear field in the second set of electrodes while providing the first substantially field-free region between the ion source and the first set of electrodes.

Acceleration Potential

The controller is configured to control the set of power supplies to optionally change the acceleration potential V_{acceleration} applied to the second set of electrodes during the time period Δt=t_{off}−tₒₙ, wherein tₒₙ>t_{extraction}, to vary acceleration of the extracted group of ions based, at least in part, on respective mass-to-charge ratios. It should be understood that the acceleration potential V_{acceleration} is changed during the time period Δt=t_{off}−tₒₙ and thus the acceleration potential V_{acceleration} is time-dependent. It should be understood that the acceleration potential V_{acceleration} is applied from a time tₒₙ until a later time t_{off}. In one example, the acceleration potential V_{acceleration} applied to the second set of electrodes during the time period Δt=t_{off}−tₒₙ is a time-dependent acceleration potential V_{acceleration}.

As described above, by changing the acceleration potential V_{acceleration} applied to the second set of electrodes during the time period Δt=t_{off}−tₒₙ to vary acceleration of the extracted group of ions based, at least in part, on respective mass-to-charge ratios, ions having relatively higher mass-to-charge ratios, for example, and traversing through the second set of electrodes at relatively later times are accelerated by a relatively changed, for example an increased, accelerating field due to the second set of electrodes compared with ions having relatively lower mass-to-charge ratios, for example, and traversing through the second set of electrodes at relatively earlier times. In this way, the relatively slower third ion, having the third mass-to-charge ratio m₃/z₃, is subject to an increased accelerating field, for example, compared with the relatively faster first ion having the first mass-to-charge ratio m₁/z₁. Particularly, ions having the same mass-to-charge ratio m/z but different initial ion energies and hence velocities are similarly subject to different accelerating fields, thereby more effectively correcting for the initial ion energy spread and thus improving mass resolution. Particularly, in this way, time focusing of ions having the same mass-to-charge ratio m/z but different initial ion energies is achieved.

It should be understood that a magnitude of the change ΔV_{acceleration} of the acceleration potential V_{acceleration} during the time period Δt=t_{off}−tₒₙ depends, at least in part, on a mass-to-charge range of interest and/or a duration of the time period Δt=t_{off}−tₒₙ. Hence, the magnitude of the change ΔV_{acceleration} of the acceleration potential V_{acceleration} during the time period Δt=t_{off}−tₒₙ may be relatively smaller for a relatively smaller mass-to-charge range of interest and conversely, relatively larger for a relatively larger mass-to-charge range of interest. In one example, a magnitude of the change ΔV_{acceleration} of the acceleration potential V_{acceleration} during the time period Δt=t_{off}−tₒₙ is in a range from 10% to 100%, preferably in a range from 25% to 75% of the acceleration potential V_{acceleration}. In one example, a magnitude of the change ΔV_{acceleration} of the acceleration potential V_{acceleration} during the time period Δt=t_{off}−tₒₙ is in a range from 0.1 kV to 10 kV, preferably in a range from 0.5 kV to 5 kV.

It should be understood that a duration of the time period Δt=t_{off}−tₒₙ depends, at least in part, on a mass-to-charge range of interest and/or a rate of change of the acceleration potential V_{acceleration} during the time period Δt=t_{off}−tₒₙ. Preferably, all of the ions in the mass-to-charge range of interest, for example the first ion, the second ion and the third ion, are within the second acceleration stage (i.e. traversing the second set of electrodes and hence between the first electrode and the Nth electrode of the second set of electrodes) at the start tₒₙ of the change ΔV_{acceleration} of the acceleration potential V_{acceleration} and the ion having the largest mass-to-charge ratio, for example the third ion, is at, or beyond, the exit of the second acceleration stage (i.e. at or beyond the second set of electrodes and hence at or beyond the Nth electrode of the second set of electrodes) at the end t_{off} for time focusing to be achieved over this mass-to-charge range. In one example, a duration of the time period Δt=t_{off}−tₒₙ is in a range from 1 μs to 100 μs, preferably in a range from 5 μs to 50 μs, more preferably in a range from 15 μs to 40 μs.

In one example, the controller is configured to control the set of power supplies to change a magnitude of the acceleration potential V_{acceleration} applied to the second set of electrodes monotonically during the time period Δt=t_{off}−tₒₙ. It should be understood that the magnitude of the acceleration potential V_{acceleration} applied to the second set of electrodes is based, at least in part, on respective mass-to-charge ratios while the acceleration potential V_{acceleration} is time-dependent. Hence, by changing the magnitude of the acceleration potential V_{acceleration} monotonically during the time period, a voltage ramp is applied to the second set of electrodes. In one example, the controller is configured to control the set of power supplies to quasi-linearly or linearly change the acceleration potential V_{acceleration} applied to the second set of electrodes during the time period Δt=t_{off}−tₒₙ. Preferably, the acceleration potential V_{acceleration} applied to the second set of electrodes during the time period Δt=t_{off}−tₒₙ is changed linearly i.e. with time. In this way, the acceleration field in the second stage of acceleration changes directly proportional to the respective mass-to-charge ratios of the ions and thus provides the best possible improvement in mass resolution the second stage of acceleration. However, in generating sufficiently reproducible linear voltage ramps, over the relatively short time period Δt=t_{off}−tₒₙ and/or relatively large change in acceleration potential, is not trivial and hence an approximation to a linear voltage ramp may be used. Such an approximation to a linear is thus termed quasi-linear in this context. A quasi-linear voltage ramp may be provided by and RC exponential ramp, for example. In one example, a root mean square, RMS, deviation of the change in the acceleration potential V_{acceleration} applied to the second set of electrodes during the time period Δt=t_{off}−tₒₙ is at most 5%, preferably at most 2.5%, preferably at most 1% with respect to a linear change in the acceleration potential V_{acceleration} applied to the second set of electrodes during the time period Δt=t_{off}−tₒₙ. In one example, a maximum deviation of the change in the acceleration potential V_{acceleration} applied to the second set of electrodes during the time period Δt=t_{off}−tₒₙ is at most 10%, preferably at most 5%, preferably at most 2.5% with respect to a linear change in the acceleration potential V_{acceleration} applied to the second set of electrodes during the time period Δt=t_{off}−tₒₙ.

Pressure

It should be understood that the TOF MS is maintained, in use, at vacuum, for example at an operating pressure of at most 5×10⁻⁵ mbar, preferably of at most 5×10⁻⁶ mbar. That is, the ion source, the first set of electrodes, the second set of electrodes and the detector are maintained at such a vacuum, such that the first substantially field-free region and the second substantially field-free region are maintained at such a vacuum. In one example, the TOF MS does not comprise a gas inlet for supplying a gas, for example a collision gas or a reaction gas, to the ion source, the first set of electrodes and/or the second set of electrodes.

Mass Range and Mass Resolution

In one example, the TOF MS has a mass range in a range from 50 Da to 50 kDa, preferably in a range from 0.5 kDa to 35 kDa, more preferably in a range from 1 kDa to 25 kDa, most preferably in a range from 2 kDa to 17 kDa. In one example, the TOF MS has a mass resolution in a range from 100 to 10,000, preferably in a range from 250 to 5,000, more preferably in a range from 500 to 2,750, wherein the mass resolution is according to the IUPAC definition, for example across the mass range.

### Preferred Example

In one preferred example, the TOF MS is a linear TOF MS and comprises:

the ion source, wherein the ion source is a LDI ion source, for supplying the group of ions, including the first ion having the first mass-to-charge ratio m₁/z₁, the second ion having the second mass-to-charge ratio m₂/z₂ and the third ion having the third mass-to-charge ratio m₃/z₃ wherein m₃/z₃>m₂/z₂>m₁/z₁, at the time t₀;

the first set of electrodes, consisting of the first electrode, and the second set of electrodes, including the first electrode and the Nth electrode, wherein the first set of electrodes and the second set of electrodes are mutually spaced apart by the gap therebetween;

the ion detector for detecting the ions;

the set of power supplies, including the first power supply, electrically coupled to the first set of electrodes and to the second set of electrodes; and

the controller configured to control the set of power supplies to apply respective potentials to the first set of electrodes and the second set of electrodes;

wherein the controller is configured to control the set of power supplies to:

provide the first substantially field-free region between the ion source and the first set of electrodes to allow the group of ions to expand theretowards and/or therein, at the time t₀ for a time period t_{delay}=t_{extraction}−t₀;

apply the extraction potential V_{extraction} to the first set of electrodes at a time t_{extraction}>t₀, to extract the expanded group of ions, while maintaining the second substantially field-free region beyond the first set of electrodes, in the gap between the first set of electrodes and the second set of electrodes, during a duration from the time t_{extraction} to the time tₒₙ>t_{extraction}; and

quasi-linearly or linearly change the acceleration potential V_{acceleration} applied to the second set of electrodes during the time period Δt=t_{off}−tₒₙ, wherein tₒₙ>t_{extraction}, to vary acceleration of the extracted group of ions based, at least in part, on respective mass-to-charge ratios.

Method of Controlling a TOF MS

The second aspect provides a method of controlling a time-of-flight, TOF, mass spectrometer, MS, the method comprising:

supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, from an ion source at a time t₀ and allowing the group of ions to expand towards and/or into a first substantially field-free region between the ion source and a first set of electrodes, including a first electrode;

applying an extraction potential V_{extraction} to the first set of electrodes at a time t_{extraction}>t₀, to extract the expanded group of ions, while maintaining a second substantially field-free region beyond the first set of electrodes, in a gap between the first set of electrodes and a second set of electrodes, including a first electrode and an Nth electrode, wherein the first set of electrodes and the second set of electrodes are mutually spaced apart by the gap;

optionally, changing an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios; and

detecting the ions.

The TOF MS, supplying the group of ions, including the first ion, the second ion and the third ion, the ion source, the time t₀, the first set of electrodes including the first electrode, applying the extraction potential V_{extraction}, the time t_{extraction}>t₀, the first substantially field-free region, the second substantially field-free region, the gap, the second set of electrodes, including the first electrode and the Nth electrode, applying the acceleration potential V_{acceleration}, the time period Δt=t_{off}−tₒₙ and/or detecting the ions may be as described with respect to the first aspect, mutatis mutandis. The second aspect may include any step and/or feature described with respect to the first aspect, mutatis mutandis.

In one example, the method comprises providing the first substantially field-free region between the ion source and the first set of electrodes by applying a static voltage V_{B} to the first set of electrodes.

In one example, the method comprises providing the first substantially field-free region between the ion source and the first set of electrodes during a time period t_{delay}=t_{extraction}−t₀.

In one example, the method comprises providing a substantially linear field in the second acceleration stage while providing the first substantially field-free region between the ion source and the first set of electrodes.

In one example, maintaining the second substantially field-free region beyond the first set of electrodes, in the gap between the first set of electrodes and the second set of electrodes, comprises maintaining the second substantially field-free region beyond the first set of electrodes, in the gap between the first set of electrodes and the second set of electrodes, to at most 1% of the extraction potential V_{extraction} mm.

In one example, a length of the gap between the first set of electrodes and the second set of electrodes is at least a diameter of an ion aperture in the first set of electrodes or the second set of electrodes.

In one example, changing the acceleration potential V_{acceleration} applied to the second set of electrodes during the time period Δt=t_{off}−tₒₙ comprises changing a magnitude of the acceleration potential V_{acceleration} applied to the second set of electrodes monotonically during the time period Δt=t_{off}−tₒₙ.

In one example, changing the acceleration potential V_{acceleration} applied to the second set of electrodes during the time period Δt=t_{off}−tₒₙ comprises quasi-linearly or linearly changing the acceleration potential V_{acceleration} applied to the second set of electrodes during the time period Δt=t_{off}−tₒₙ.

In one example, the first set of electrodes consists of the first electrode.

In one example, the method comprises independently applying respective voltages to the first set of electrodes and to the second set of electrodes.

Computer, Computer Program, Non-Transient Computer-Readable Storage Medium

The third aspect provides a computer comprising a processor and a memory configured to implement, at least in part, a method according to the second aspect.

The fourth aspect provides a computer program comprising instructions which, when executed by a computer comprising a processor and a memory, cause the computer to perform, at least in part, a method according to the second aspect.

The fifth aspect provides a non-transient computer-readable storage medium comprising instructions which, when executed by a computer comprising a processor and a memory, cause the computer to perform, at least in part, a method according to the second aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1(a) schematically depicts a TOF MS according to an exemplary embodiment; FIG. 1(b) schematically depicts a potential diagram for the TOF MS at a time t₀; FIG. 1(c) schematically depicts a potential diagram for the TOF MS at a time t_{extraction}>t₀; FIG. 1(d) schematically depicts a potential diagram for the TOF MS at a time tₒₙ>t_{extraction}; and FIG. 1(e) schematically depicts a potential diagram for the TOF MS at a time t_{off}>tₒₙ;

FIG. 2 schematically depicts the TOF MS of FIG. 1(a), in more detail;

FIG. 3 schematically depicts an extraction potential V_{extraction} applied to the first set of electrodes of the TOF MS of FIG. 1(a) at a time t_{extraction}>t₀;

FIG. 4 schematically depicts an acceleration potential V_{acceleration} applied to the second set of electrodes of the TOF MS of FIG. 1(a) during a time period Δt=t_{off}−tₒₙ, wherein tₒₙ>t_{extraction};

FIG. 5 schematically depicts a simulation of the TOF MS of FIG. 1(a);

FIG. 6 schematically depicts results of the simulation of FIG. 5;

FIG. 7 schematically depicts results of the simulation of FIG. 5;

FIG. 8(a) shows a mass spectrum acquired using a conventional TOF MS; and FIG. 8(b) shows a mass spectrum acquired using a TOF MS according to an exemplary embodiment;

FIG. 9 schematically depicts a method of controlling a TOF MS according to an exemplary embodiment;

FIGS. 10(a) to 10(i) schematically depict a simulation of the TOF MS of FIG. 1(a);

FIGS. 11(a) to 11(d) shows the simulation of FIGS. 10(a) to 10(i), in more detail; and

FIG. 12 schematically depicts a method of controlling a TOF MS according to an exemplary embodiment, in more detail.

### DETAILED DESCRIPTION OF THE DRAWINGS

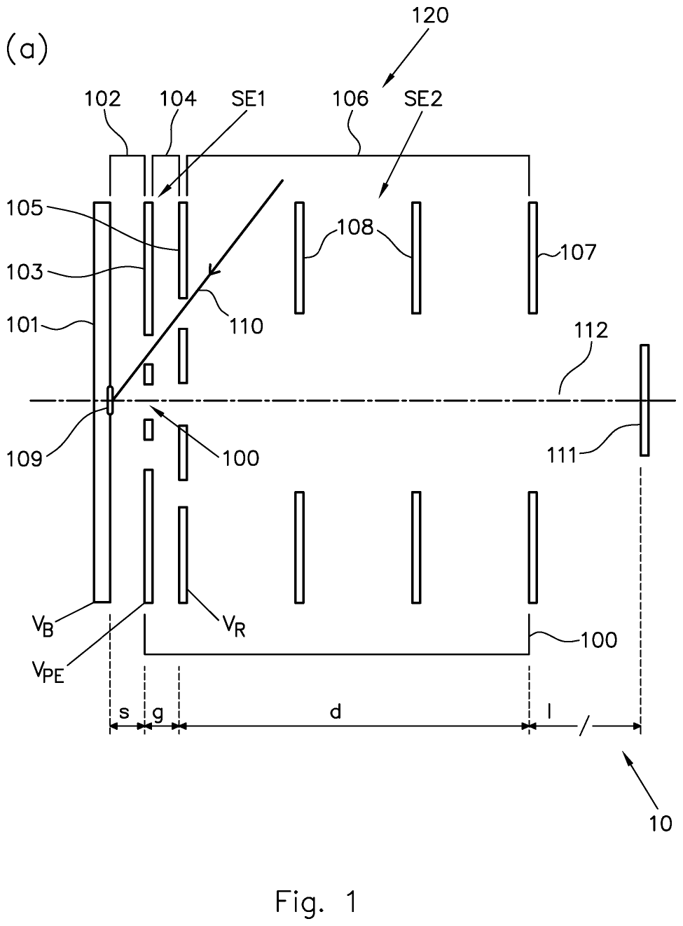

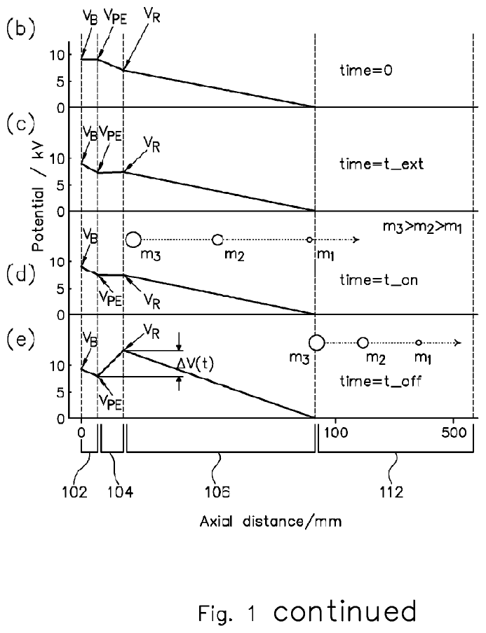

FIG. 1(a) schematically depicts a TOF MS 10 according to an exemplary embodiment; FIG. 1(b) schematically depicts a potential diagram for the TOF MS 10 at a time t₀; FIG. 1(c) schematically depicts a potential diagram for the TOF MS 10 at a time t_{extraction}>t₀; FIG. 1(d) schematically depicts a potential diagram for the TOF MS 10 at a time tₒₙ>t_{extraction}; and FIG. 1(e) schematically depicts a potential diagram for the TOF MS 10 at a time t_{off}>tₒₙ. Particularly, FIGS. 1(a)-(e) show a schematic diagram of a linear TOF MS 10 incorporating a multiple-stage acceleration configuration according to an exemplary embodiment and related potential diagrams.

In this example, the TOF MS comprises:

an ion source 109, 110 for supplying a group of ions, including a first ion m₁ having a first mass-to-charge ratio m₁/z₁, a second ion m₂ having a second mass-to-charge ratio m₂/z₂ and a third ion m₃ having a third mass-to-charge ratio m₃/z₃ wherein m₃/z₃>m₂/z₂>m₁/z₁, at a time t₀ (time=0);

a first set of electrodes SE1, including a first electrode 103, and a second set of electrodes SE2, including a first electrode 105 and an Nth electrode 107, wherein the first set of electrodes SE1 and the second set of electrodes SE2 are mutually spaced apart by a gap g therebetween;

an ion detector 111 for detecting the ions;

a set of power supplies (not shown), including a first power supply (not shown), electrically coupled to the first set of electrodes SE1 and to the second set of electrodes SE2; and

a controller (not shown) configured to control the set of power supplies to apply respective potentials to the first set of electrodes SE1 and the second set of electrodes SE2;

wherein the controller is configured to control the set of power supplies to:

provide a first substantially field-free region between the ion source and the first set of electrodes to allow the group of ions to expand theretowards and/or therein, at the time t₀;

apply an extraction potential V_{extraction} (V_{PE}−V_{B}) to the first set of electrodes SE1 at a time t_{extraction}>t₀ (time=t_ext), to extract the expanded group of ions, while maintaining a second substantially field-free region 104 beyond the first set of electrodes SE1, in the gap g between the first set of electrodes SE1 and the second set of electrodes SE2; and

change an acceleration potential V_{acceleration} (V_{R}) applied to the second set of electrodes during a time period Δt=t_{off}−tₒₙ=t_{off}−t_on, wherein tₒₙ>t_{extraction}, to vary acceleration of the extracted group of ions based, at least in part, on respective mass-to-charge ratios.

In this example, the TOF MS comprises and/or is a linear TOF MS, for example having a linear flight tube arranged between the second set of electrodes and the detector.

In this example, the ion source is a MALDI ion source (pulsed laser energy 110 shown, passing through apertures in electrodes 103 and 105). In this example, the ion source comprises, in use, a MALDI sample plate 101, having a sample 109 thereon. In this example, the first electrode 103 of the first set of electrodes SE1 comprises a plate, having an ion aperture therethrough. In this example, the first set of electrodes consists of the first electrode 103. In this example, a diameter D of the first electrode and/or of the Mth electrode of the first set of electrodes is at least twice a length g of the gap. In this example, the second set of electrodes SE2 includes N electrodes 105, 108, 108 and 107, including the first electrode 105 and the Nth electrode 107, wherein N is a equal to 4, wherein the N electrodes are mutually spaced apart, preferably mutually equispaced apart. In this example, a diameter D of the first electrode 105 of the second set of electrodes SE2 is at least twice a length g of the gap. In this example, a length g (also known as axial extent) of the gap between the first set of electrodes SE1 and the second set of electrodes SE2 is at least a diameter d of an ion aperture 100 in the first set of electrodes SE1, for example in the first electrode 103, and the second set of electrodes, for example in the first electrode 105 thereof. In this example, the ion detector 111 is a microchannel plate, MCP, detector.

In more detail, FIG. 1(a) is a schematic diagram of the TOF MS 10 showing a set of parallel electrodes (i.e. the first set of electrodes SE1 and the second set of electrodes SE2) with apertures 100, positioned at a distance ‘s’ from, and parallel to, a solid sample plate 101, that together form a multiple-stage acceleration configuration 120. The ion detector 111 is located at a distance ‘l’ from the multiple-stage acceleration configuration 120, between which is a field free region 112.

The first substantially field-free region, of length ‘s’, is provided between the sample plate 101 and the first electrode 103 of the first set of electrodes SE1 of the first set of electrodes SE1, during ablation and ionisation of the sample 109. This first substantially field-free region eliminates the prompt acceleration of ions and distortion of phase space during the time-delay prior to the application of the extraction pulse, due, for example, to the electrical fields therebeyond in the gap 104 of length ‘g’. Elimination of the prompt acceleration effect allows for a more precise correlation between initial ion position and initial velocity to be established at the onset of the extraction voltage pulse, which has a strong effect on mass resolving power. Subsequently, the first acceleration stage 102, of length ‘s’, is formed between the sample plate 101 and the first electrode 103 of the first set of electrodes SE1 of the first set of electrodes SE1 (i.e. the first substantially field-free region becomes the first acceleration stage 102) and simultaneously, the field free gap 104 (i.e. the second substantially field-free region), of length ‘g’, is formed between the first electrode 103 of the first set of electrodes SE1 and the first electrode 105 of the second set of electrodes SE2. This second substantially field-free region eliminates distortion phase space in the first pulsed extraction stage 102, due, for example, to the second acceleration stage 106 of the second set of electrodes SE2, which would otherwise adversely affect mass resolving power. The second acceleration stage 106, of length ‘d’, is formed between the first electrode 105 of the second set of electrodes SE2 and the Nth electrode 107 of the second set of electrodes SE2, with several intermediate electrodes 108 (two shown) distributed evenly through the second acceleration stage 106.

The voltages applied to the electrodes that form the multiple-stage acceleration configuration are shown in FIG. 1(b-e). V_{B}, V_{PE} and V_{R} are the voltages applied to the sample plate 101, the first electrode 103 of the first set of electrodes SE1 and the first electrode 105 of the second set of electrodes SE2 respectively. The Nth electrode 107 of the second set of electrodes SE2 is connected to ground potential, with the intermediate electrodes 108 connected in series between the first electrode 105 of the second set of electrodes SE2 and the Nth electrode 107 of the second set of electrodes SE2 by a chain of resistors and capacitors that maintain a linear potential gradient across the second acceleration stage 106. The actual number of intermediate electrodes 108 required in the second acceleration stage 106 depends on the specific geometry with a larger number required for smaller diameter electrodes to prevent significant radial field penetration into the relatively long second acceleration stage 106.

FIG. 1(b) shows the potential distribution across the multiple-stage acceleration configuration 120 when the pulsed laser energy 110 is incident on the sample 109 located on the sample plate 101 (time=0):
1. A static voltage V_{B} is supplied to the sample plate 101;
2. A static voltage V_{PE} is initially supplied to the first electrode 103 of the first set of electrodes SE1, equal to the voltage on the sample plate 101, V_{PE}=V_{B}, thus initially establishing a field free region across the first acceleration stage 102 into which the desorbed ion plume can expand prior to the application of the time-delayed extraction pulse; and
3. A static voltage V_{R}, ‘ramp bias’ is initially supplied to the first electrode 105 of the second set of electrodes SE2 and, with the Nth electrode 107 of the second set of electrodes SE2 grounded, forms a linear static field (V_{R}/d) across the second acceleration stage 106.

FIG. 1(c) shows the potential distribution across the multiple-stage acceleration configuration 120, after a time-delay (t_{extraction}), of typically a few hundred ns, following the irradiation of the sample plate 101 by the laser radiation 110, when an extraction field is pulsed across the first acceleration stage 102:
1. The voltage V_{PE} supplied to the first electrode 103 is pulsed, from a voltage equal to that supplied to the sample plate 101 (V_{PE}=V_{B}), to a voltage equal to that on the first electrode 105 of the second set of electrodes SE2 (V_{PE}=V_{R}), thus establishing an extraction acceleration field between the sample plate 101 and the first electrode 103 of the first set of electrodes SE1 (V_{B}−V_{PE}/s) and a field free gap between the first electrode 103 and the first electrode 105 of the second set of electrodes SE2 (V_{PE}=V_{R}); and
2. The field free gap 104 is an important advantage of this invention, eliminating electric field penetration from the second accelerating stage 106 into the first pulsed extraction stage 102, thereby eliminating distortion phase space in the first pulsed extraction stage 102, which would otherwise adversely affect mass resolving power.

FIG. 1(d) and FIG. 1(e) show the potential distribution through the multiple-stage acceleration configuration 120 at times tₒₙ and t_{off} respectively. At tₒₙ, the ions in the m/z range of interest (say m₁ to m₃), must have passed through the field free gap 104 and into the second acceleration stage 106 (FIG. 1(d)). The faster (m₁), lower m/z, ions of interest will be at the Nth electrode 107 of the second set of electrodes SE2, the exit of the second acceleration stage 106, and the slower (m₃), higher m/z, ions of interest will be at the first electrode 105 of the second set of electrodes SE2, the entry to the second acceleration stage 106.

During the period tₒₙ to t_{off} the potential distribution across the second acceleration stage 106 is modified by a time-dependent voltage ramp ΔV(t) of duration Δt=t_{off}−tₒₙ, applied to the first electrode 105 of the second set of electrodes SE2, whereby heavier ions traversing this stage 106 at later times experience a linear, most preferably a quasi-linear, increase in the magnitude of the accelerating field thus enhancing mass resolving power over the extended m/z range of interest.

All the ion over the m/z range of interest (m₁ to m₃) must be within this second acceleration stage 106 at the onset (tₒₙ) of the dynamic ramp (FIG. 1(d)) and the highest m/z of interest (m₃) must be at, or beyond, the exit of the second acceleration stage 106 at t_{off} (FIG. 1(d)) for time focusing to be achieved over this extended m/z range.

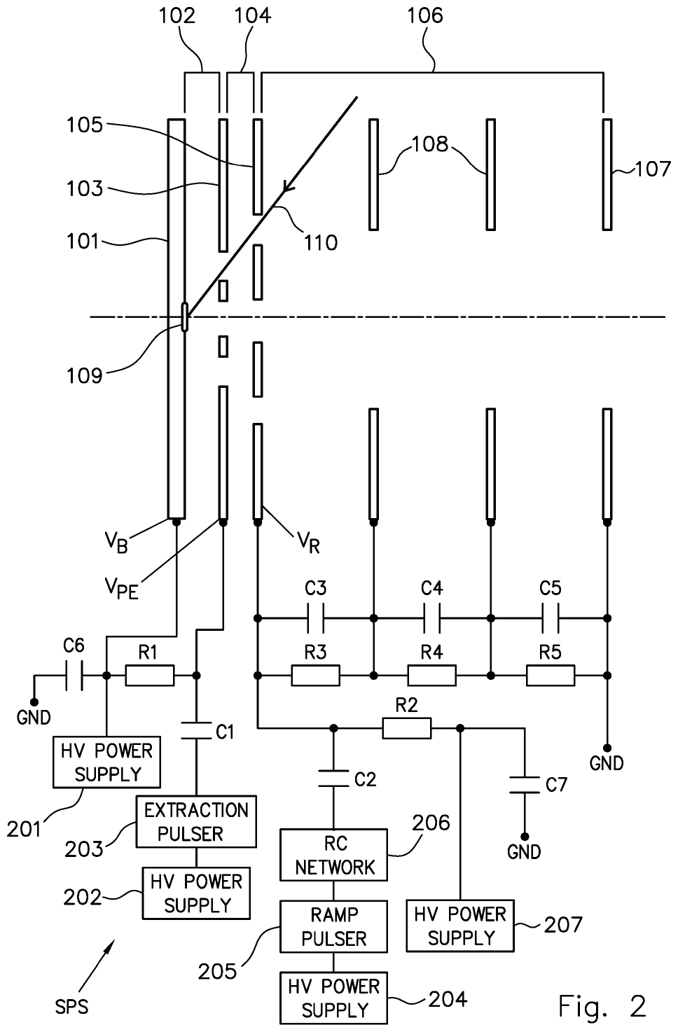

FIG. 2 schematically depicts the TOF MS 10 of FIG. 1(a), in more detail. Particularly, FIG. 2 shows a schematic diagram of the multiple-stage acceleration configuration and associated HV electronics.

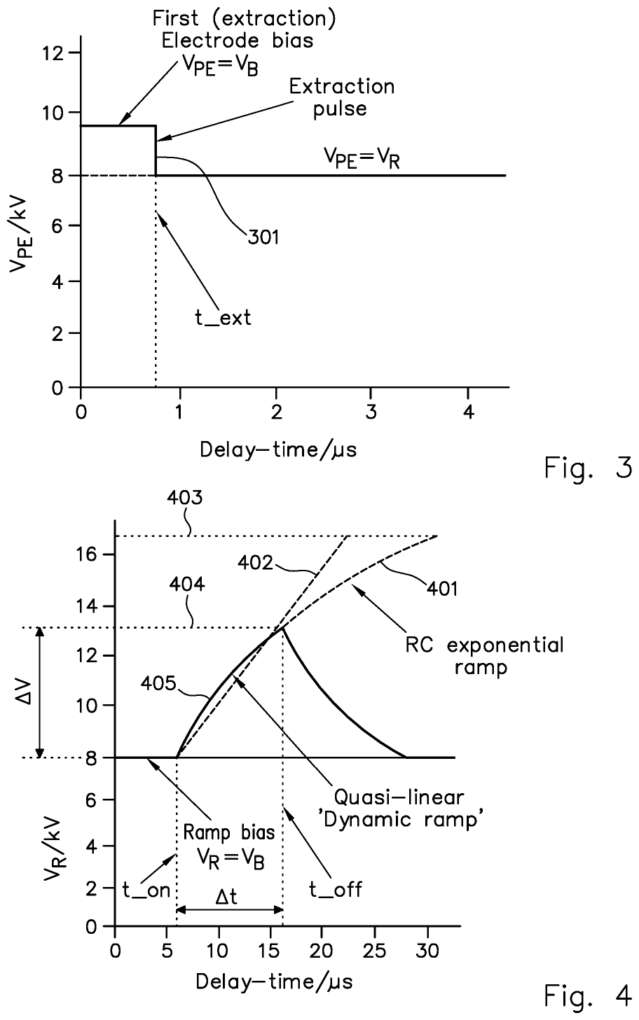

FIG. 3 schematically depicts an extraction potential V_{extraction} applied to the first set of electrodes of the TOF MS 10 of FIG. 1(a) at a time t_{extraction}>t₀. Particularly, FIG. 3 shows a potential plot for an extraction pulse applied across the first acceleration stage.

FIG. 4 schematically depicts an acceleration potential V_{acceleration} applied to the second set of electrodes of the TOF MS 10 of FIG. 1(a) during a time period Δt=t_{off}−tₒₙ, wherein tₒₙ>t_{extraction} Particularly, FIG. 4 shows a potential plot for a quasi-linear ‘dynamic ramp’ applied across the second acceleration stage.

FIG. 2 is a schematic of the preferred electronic configuration. As previously stated, this invention overcomes several limitations of other approaches to the utilization of multiple time varying potentials. The introduction of the short intermediate field-free gap 104, created between two consecutive electrodes, decouples the application of the extraction voltage pulse across the first extraction stage 102 and the application of the high voltage dynamic ramp across the second acceleration stage 106, which would otherwise complicate the analogue electronics design considerably. For example, HV pulsing induces different DC offsets (depending on duty cycle and amplitude of the pulse) on the first (extraction) electrode 103 and third (ramp) electrode 105 that can only be effectively tuned out by adjusting the bias PSUs independently, which can only be done by decoupling the application of the extraction and ramp pulses as revealed in this invention.

In this example, the set of power supplies SPS includes the first power supply 202 electrically coupled, for example only electrically coupled, to the first set of electrodes SE1, a second power supply 204 electrically coupled, for example only electrically coupled, to the second set of electrodes SE2 and a third power supply 201 electrically coupled, for example only electrically coupled, in use to the sample plate 101. In this example, the set of power supplies SPS includes a fourth power supply 207 electrically coupled, for example only electrically coupled, to the second set of electrodes SE2.
1. A static voltage V_{B} is supplied to the sample plate 101 by a high voltage power supply 201, which also provides a voltage bias to the first electrode 103 via resistor R1, thus ensuring an initial field free region 102 between the sample plate 101 and the first electrode 103 of the first set of electrodes SE1 before the time-delayed extraction pulse is applied to the first electrode 103 at a time t_{extraction} after irradiation of sample plate 101 by laser energy 110.
2. The extraction pulse 301, applied to the first electrode 103, is derived from a high voltage power supply 202 and high voltage ‘Extraction Pulser’ unit 203 coupled to the first electrode 103 via capacitor C1. The extraction pulse 301 drops the potential V_{PE} on the first electrode 103 from the sample plate potential, V_{PE}=V_{B}, to the ramp bias potential, V_{PE}=V_{R}, on the first electrode 105 of the second set of electrodes SE2, thus establishing the pulsed extraction field across the first acceleration stage 102 and the field free gap 104 that ensures no field penetration from second acceleration stage 106 into the first acceleration stage 102 during the extraction phase.
3. A static voltage V_{R}, ‘ramp bias’, is supplied to the first electrode 105 of the second set of electrodes SE2, start of second acceleration stage 106, by a high voltage power supply 207, biasing this electrode to the same voltage as the potential on the first electrode (V_{R}=V_{PE}) after the extraction pulse has been applied to the first electrode 103. The time-dependent ‘dynamic ramp’ is formed by high voltage power supply 204 and high voltage ‘Ramp Pulser’ 205 driving the ‘RC network’ 206, coupled to the first electrode 105 of the second set of electrodes SE2 by capacitor C2, to derive the quasi-linear change in the field across the second acceleration stage 106.
4. The HV pulse applied across the RC network 206 gives rise to an exponential ramp 401 (FIG. 4) that deviates significantly from the ‘ideal’ linear ramp 402. However, by applying a much higher potential 403 across the RC network than the amplitude required for the actual ‘dynamic ramp’ 404, it is possible to achieve a quasi-linear ramp 405 over the required ‘dynamic ramp’ duration Δt=t_{off}−tₒₙ. The pulser 205, designed for this invention, is of a ‘push-pull’ configuration; driving the RC ramp ‘on’ at time tₒₙ in a positive direction and driving the ramp ‘off’ in negative direction at a time t_{off}. Thus, a quasi-linear ramp 405 of amplitude ΔV is generated over a time period Δt=t_{off}−tₒₙ. The exponential decay of the quasi-linear ramp 405 (i.e. after the time t_{off}) is not important and is due to the HV switch supplying the pulse to the RC network being of a ‘push-pull’ type. So, a positive going pulse is applied across the network and you would get the profile 401 if you waited for ‘natural’ rise of the ramp; it would rise to amplitude close to that of the ramp PSU (10 kV). That's the ‘push’ part, but the ‘pull’ part actively pulls the supply back to ground at the time t_{off} (and we get the exponential decay because connected across same RC network). This has the advantage of not having the full potential of the PSU being applied to an electrode and also driving the ramp back to zero, ready for next pulse. The latter only really being important for higher repetition rate systems. So, whilst the system would work fine with a pulse like 401, we chose to use ‘push-pull’ configuration for our implementation for the reasons give.
5. Since all of the ions in m/z range of interest must be within the second acceleration stage 106 at the onset (tₒₙ) of the dynamic ramp 405, the second acceleration stage 106 must be somewhat longer than in a traditional two-stage ion source. To ensure the field along the axis of the second acceleration stage 106 is not distorted by radial field penetration, additional electrodes 108 are evenly distributed along the length of this stage 106, connected by a series of resistors (R3, R4, R5) to evenly distribute the ‘ramp bias’ between the electrodes and a series of capacitors (C3, C4, C5) to evenly distribute the ‘dynamic ramp’ potential between the electrodes.
6. Capacitors C6 and C7 protect the extraction HV power supply 201 and ramp bias power supply 207 from overvoltage and instability during extraction and ramp pulsing operation.

In this example, the first (extraction pulse) power supply 202 is a 2.5 kV power supply unit (PSU), having a stability of <1000 ppm, for example an Applied Kilovolts HP2.5×AA025. In this example, the second (ramp pulse) power supply 204 is a 10 kV PSU having a stability of <100 ppm, for example an Applied Kilovolts HPO10×AA025. In this example, the third (source) power supply 201 is a 10 kV PSU having a stability of <100 ppm, for example an Applied Kilovolts HPO10×AA025. In this example, the fourth (ramp bias) power supply 207 is a 10 kV PSU having a stability of <100 ppm, for example an Applied Kilovolts HPO10×AA025. Reversible versions of these power supplier may be employed to enable switching between the analysis of positive and negative ions.

Ion Optics Simulation

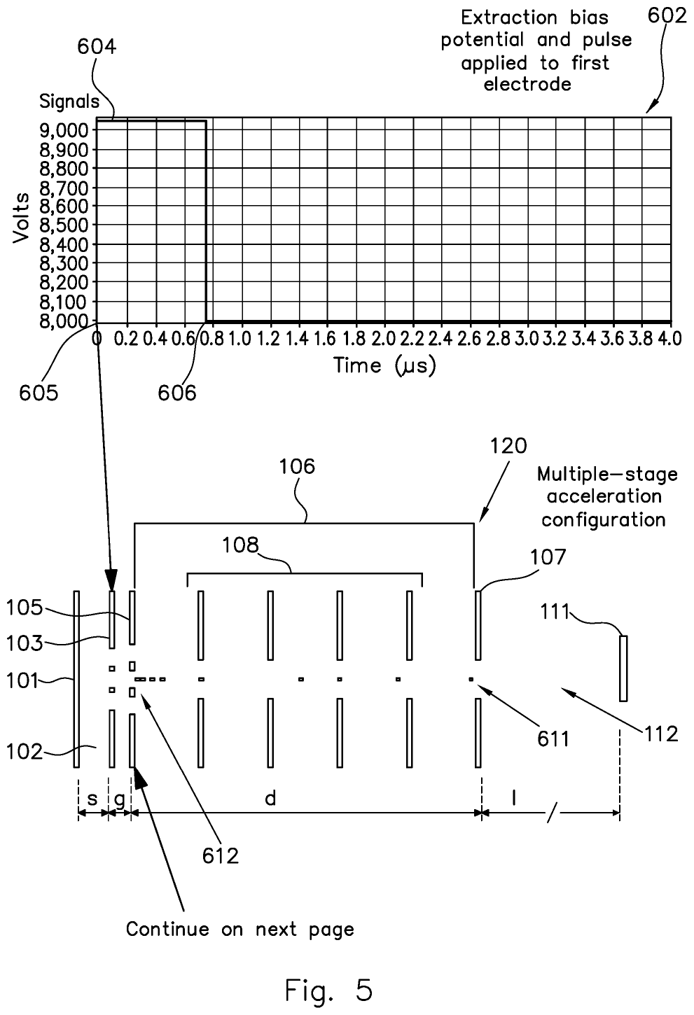

FIG. 5 schematically depicts a simulation of the TOF MS of FIG. 1(a). Particularly, FIG. 5 shows a schematic of ion optics geometry and potentials applied across acceleration stages for ion optical simulations using SIMION and SIMAX programs. The multiple-stage acceleration configuration described here, developed using the new set of analytical equations, was verified using software modelling tools SIMION and SIMAX. The parameters used for modelling purposes, shown in FIG. 5, are the preferred embodiment of the present invention. FIG. 5 shows the multiple-stage acceleration configuration geometry 120, the ‘extraction bias’ and ‘extraction pulse’ waveform 602 applied to the first electrode 103 and the ‘ramp bias’ and ‘dynamic ramp’ waveform 603 applied to the first electrode 105 of the second set of electrodes SE2.

The multiple-stage configuration 120 is shown with ion groups over a m/z range from 2 kDa 611 to 17 kDa 612 at time tₒₙ=6.3 μs 610, the start of the application of the ‘dynamic ramp’ across the second acceleration stage 106. Only the m/z range of ions, 2 kDa to 17 kDa, within the second acceleration stage 106 at this time (tₒₙ=6.3 μs) will be time focused at the detector. In this example, the length of first acceleration stage 102 s=6.4 mm, field free gap 104 g=3 mm, second acceleration stage 106 d=70 mm and field free distance 112, from exit of second acceleration stage 107 to detector 111, I=500 mm. Sample plate 101 has static potential of 9.5 kV applied, first electrode 103 is pulsed from initial potential of 9.5 kV 604 to 8 kV 605 after time delay t_{extraction}=800 ns 606, and the second electrode ramped from static ‘ramp bias’ potential of 8 kV 607 to 13 kV 608 over 10 μs window 609 after initial time-delay of 6.3 μs 610. Four intermediate electrodes 108 ensure a linear field is maintained across second acceleration stage 106 with no significant radial field penetration.

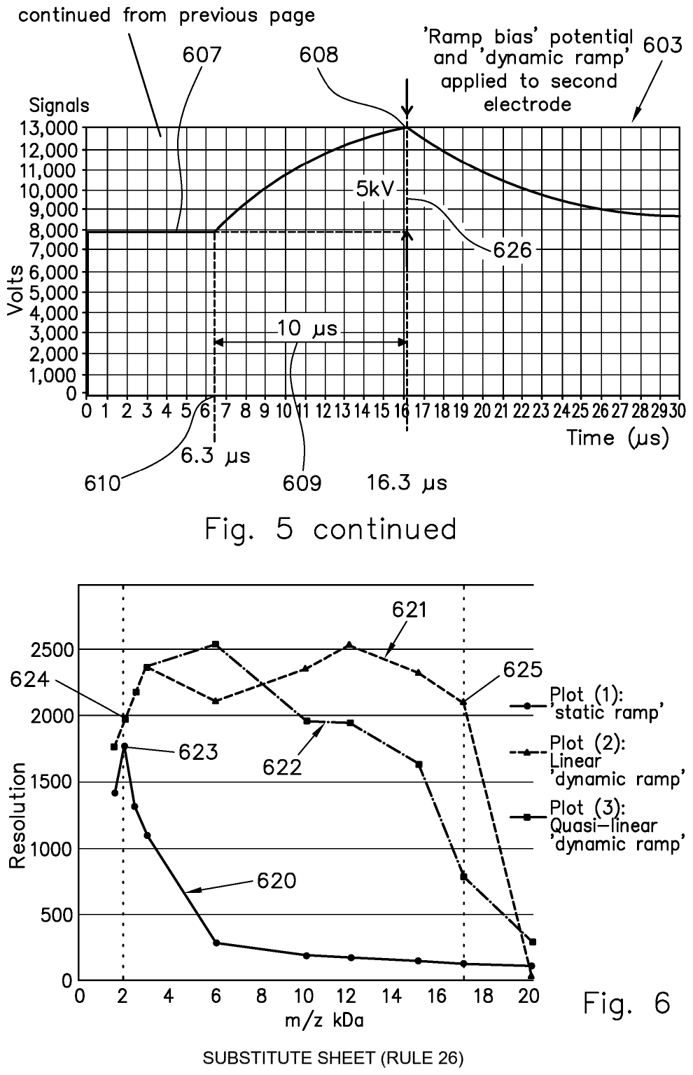

FIG. 6 schematically depicts results of the simulation of FIG. 5. Particularly, FIG. 6 shows SIMAX simulation results of resolution achieved over an extended m/z range of interest. FIG. 6 shows plot of resolution [=time_of_flight/(2*peak width (FWHM)] over m/z range of interest, here 2 kDa to 17 kDa, being the m/z range over which ions are present in the second acceleration stage 106 at the time the ‘dynamic ramp’ 603 is applied across the second acceleration stage 106 at tₒₙ=6.3 μs 610.

Plot (1) 620 shows result of simulation with amplitude of ‘dynamic ramp’, across the second acceleration stage 106, set to zero (ΔV=0 kV), that is, a static potential across the second acceleration stage 106, which is equivalent to traditional two-stage acceleration configuration. Results in sharp peak in resolution of 1800 at m/z of 2 kDa 623 (actual m/z position of peak resolution determined by delayed-extraction pulse time, here t_{extraction}=800 ns). Resolution rapidly fall away from peak value 623 with increasing m/z, as would be expected in the absence of any time-dependent acceleration scheme.

Plot (2) 621 shows the resolution obtained with application of an ‘ideal’ linear 402 ‘dynamic ramp’ (ΔV=5 kV, Δt=10 μs) applied across the second acceleration stage 106. Enhanced resolution is now obtained over the entire m/z range of interest, resolution of 2000 at 2 kDa 624 to 2200 at 17 kDa 625, demonstrating a significant improvement in resolution over this extended m/z range with respect to resolution achieved 620 in the absence of any time-dependent acceleration scheme.

Plot (3) 622 shows resolution obtained with application of practical quasi-linear ‘dynamic ramp’ 603, equivalent to 8 kV pulsed across and RC network (R=132 kΩ, C=65 pF) in 10 μs window, creating exponential ramp of amplitude ΔV=5 kV 626 over Δt=10 μs 609. Resolution 622 is reduced slightly, compared to that achieved with ‘ideal’ linear ‘dynamic ramp’ 621 at the higher end of the m/z range of interest, but resolution is still significantly enhanced with respect to the resolution obtained 620 with the ‘static ramp’ configuration, over the whole extended mass range.

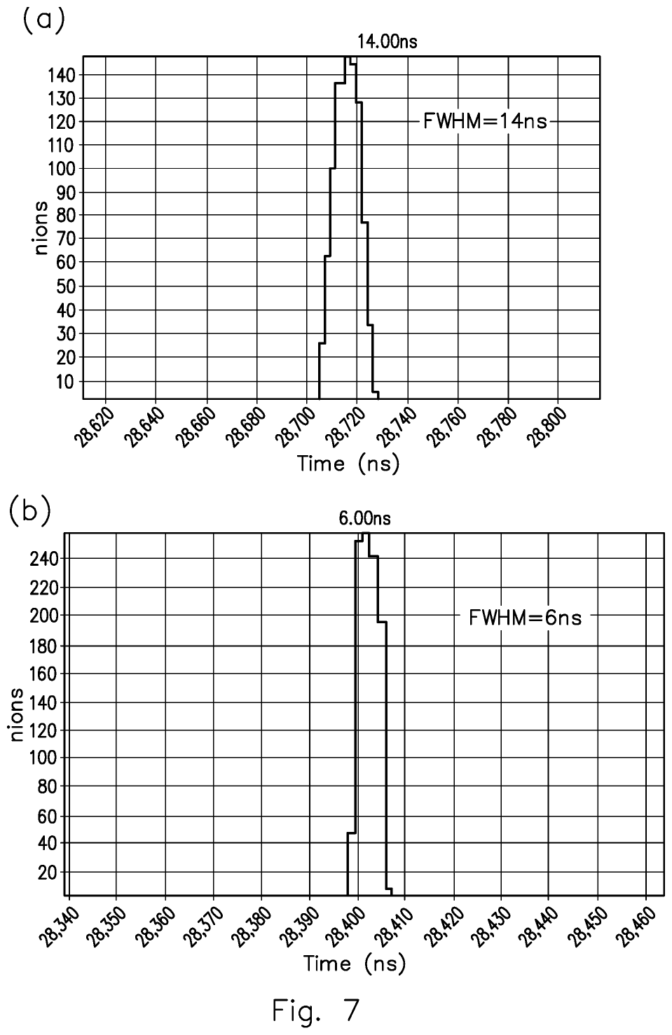

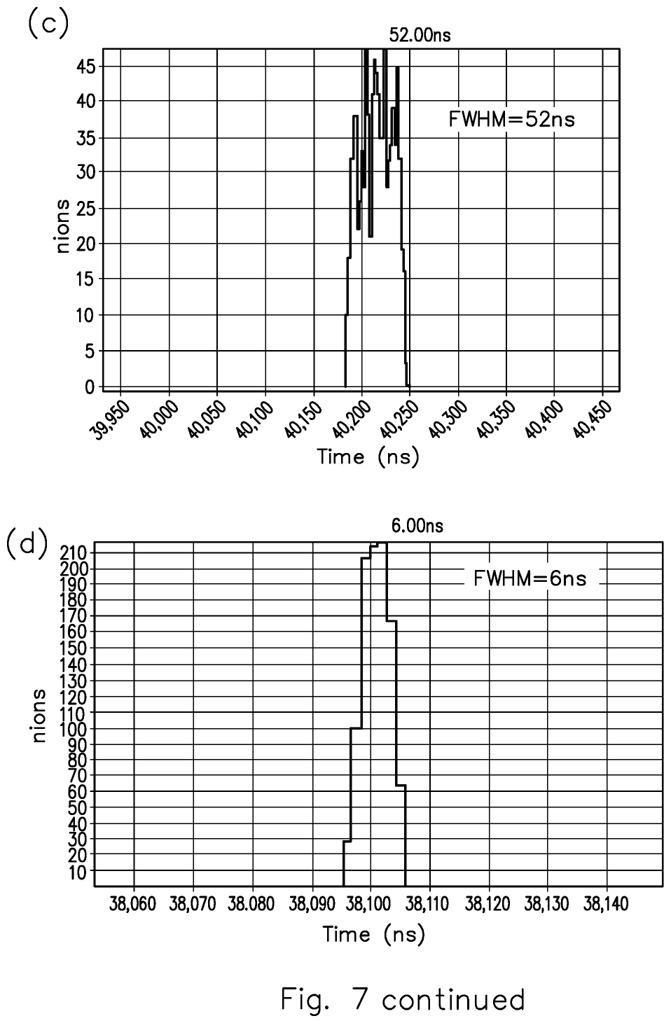

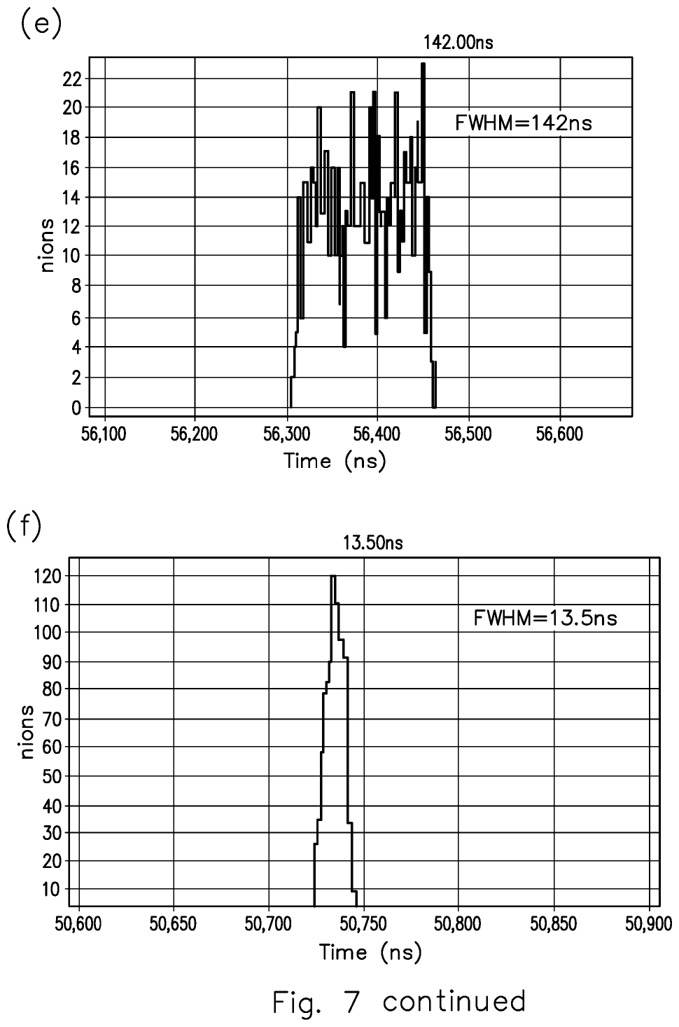

FIG. 7 schematically depicts results of the simulation of FIG. 5. Particularly, FIG. 7 shows peak shape and peak width simulation results achieved within the extended m/z range of interest.

FIG. 7 shows the peak shapes achieved, from SIMAX simulations using 3 kDa, 6 kDa and 12 kDa ions, under conditions with ‘static ramp’, equivalent to traditional two-stage source, and quasi-linear ‘dynamic ramp’ 603 applied across second acceleration stage 106. FIG. 7 (a) and (b) show peak widths (FWHM) achieved with 3 kDa ions for static and dynamic ramps to be 14 ns and 6 ns respectively. FIG. 7 (c) and (d) show peak widths (FWHM) achieved with 6 kDa ions for static and dynamic ramps to be 52 ns and 6 ns respectively. FIG. 7 (e) and (f) show peak widths (FWHM) achieved with 12 kDa ions for static and dynamic ramps to be 142 ns and 13.5 ns respectively. The peak widths are significantly reduced by the implementation of the dynamic ramp over this extended m/z range.

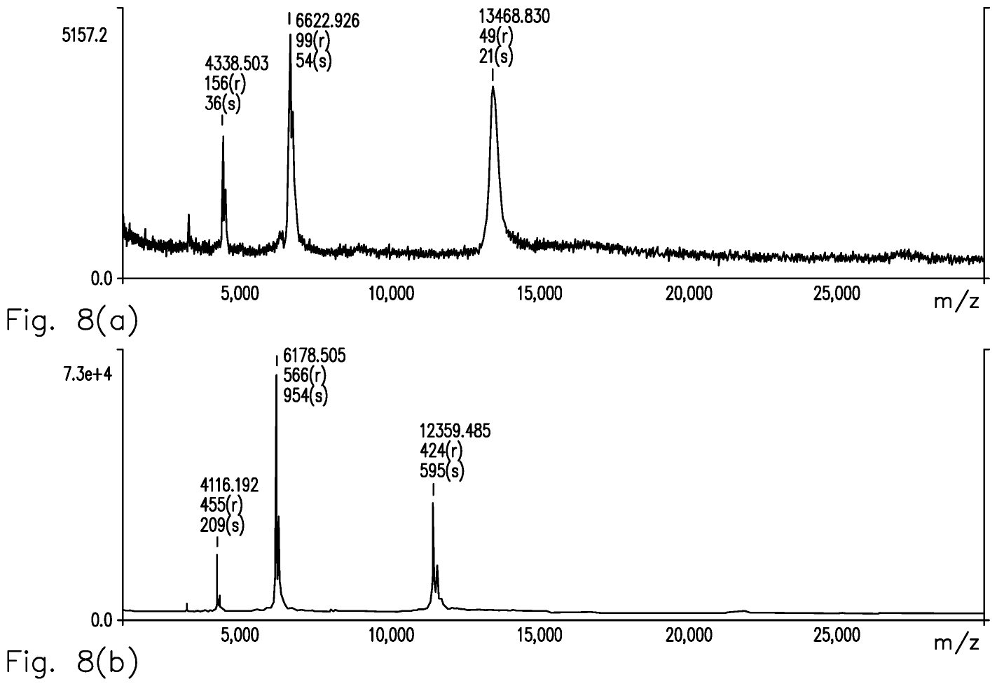

FIG. 8(a) shows a mass spectrum acquired using a conventional TOF MS (i.e. having a conventional source configuration) and FIG. 8(b) shows a mass spectrum acquired using a TOF MS according to an exemplary embodiment. Particularly, FIG. 8(b) shows experimental results achieved with a linear TOF mass spectrometer, employing multiple acceleration configuration according to an exemplary embodiment. demonstrating an improvement in mass resolution over an extended m/z range of interest, compared with the conventional TOF MS.

In more detail, FIG. 8(a) shows experimental data for species of Cytochrome C with a ‘static ramp’, equivalent to traditional two-stage configuration, applied across second acceleration stage 106 and FIG. 8(b) shows experimental data for species of Cytochrome C with a quasi-linear ‘dynamic ramp’ (ΔV=5 kV in Δt=t_{off}−tₒₙ=10 μs) applied across second acceleration stage 106. Mass spectral peaks are labelled with m/z, resolution (r) and signal-to-noise (S:N) ratio (s). Clearly, the implementation of time-dependent acceleration scheme across the second acceleration stage has significantly improved the resolution and signal-noise over an extended m/z range, in this case allowing relatively high resolution to be achieved over the m/z range of interest with a relatively short field free region 112 before the detector 111. Furthermore, the signal-to-noise (S:N) ratio for the data of FIG. 8(b) is also improved, across the whole mass range. Particularly, the improvement in resolution gives rise to much narrower peaks, and therefore higher peaks, such that the peak signal level is increased to such an extent as to dramatically increase the S:N ratio. In this way, ions of interest may be better resolved and at lower limits of detection.

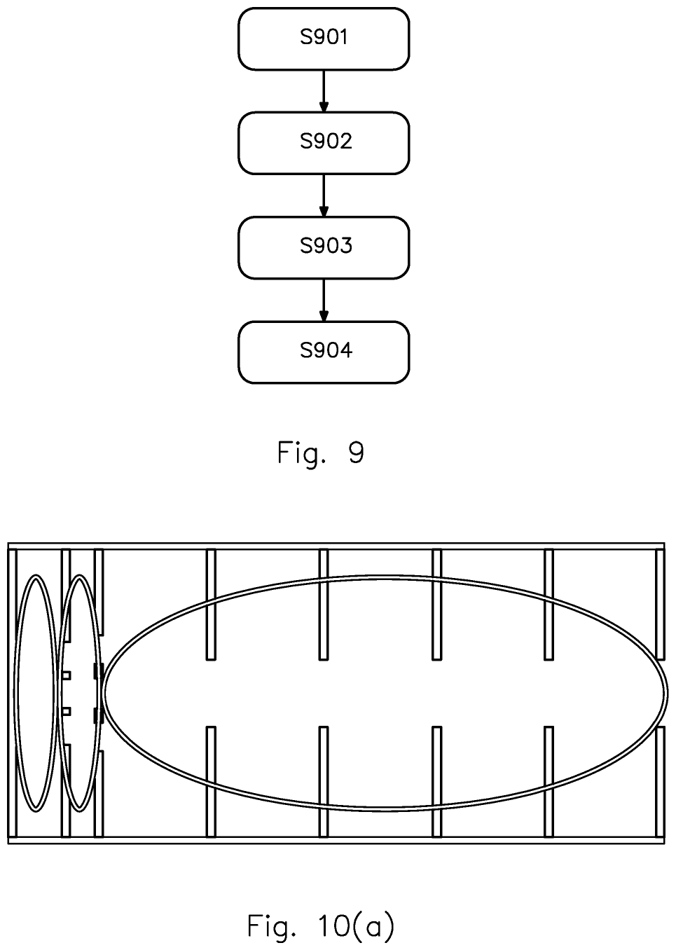

FIG. 9 schematically depicts a method of controlling a TOF MS according to an exemplary embodiment.

At S901, the method comprises supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, from an ion source at a time t₀ and allowing the group of ions to expand towards and/or into a first substantially field-free region between the ion source and a first set of electrodes, including a first electrode.

At S902, the method comprises applying an extraction potential V_{extraction} to the first set of electrodes at a time t_{extraction}>t₀, to extract the expanded group of ions, while maintaining a second substantially field-free region beyond the first set of electrodes, in a gap between the first set of electrodes and a second set of electrodes, including a first electrode and an Nth electrode, wherein the first set of electrodes and the second set of electrodes are mutually spaced apart by the gap.

At S903, the method comprises optionally, changing an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios.

At S904, the method comprises detecting the ions.

The method may include any of the steps described herein.

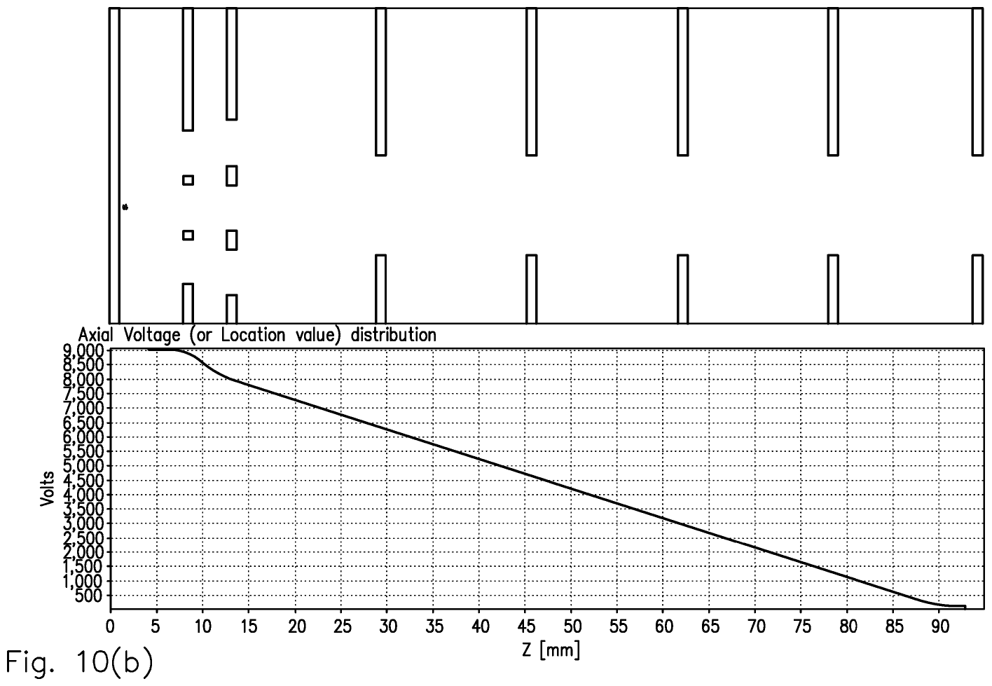

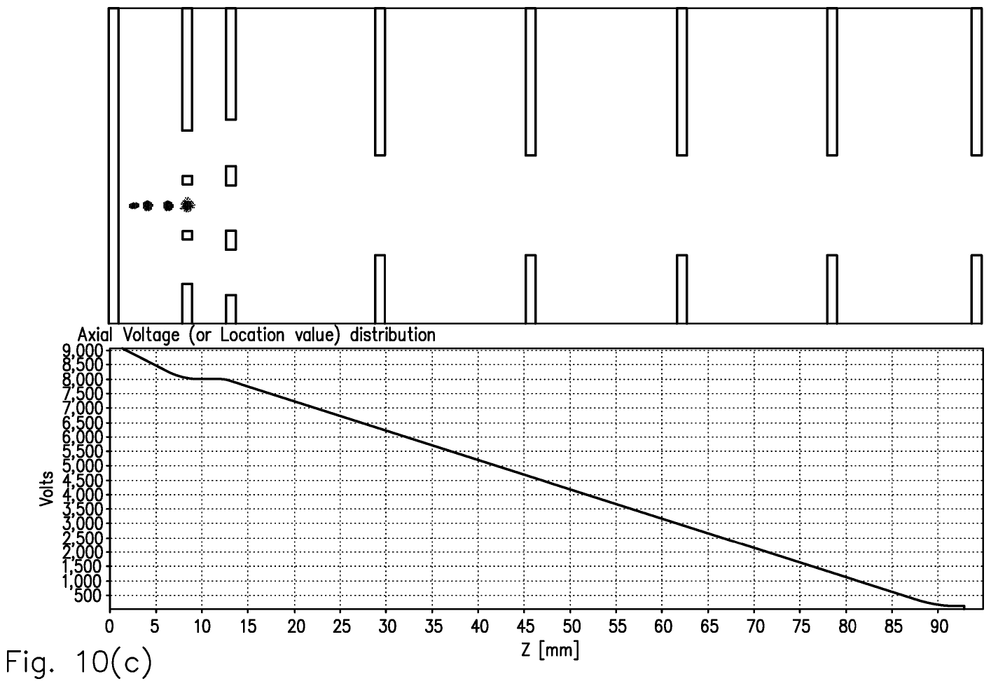

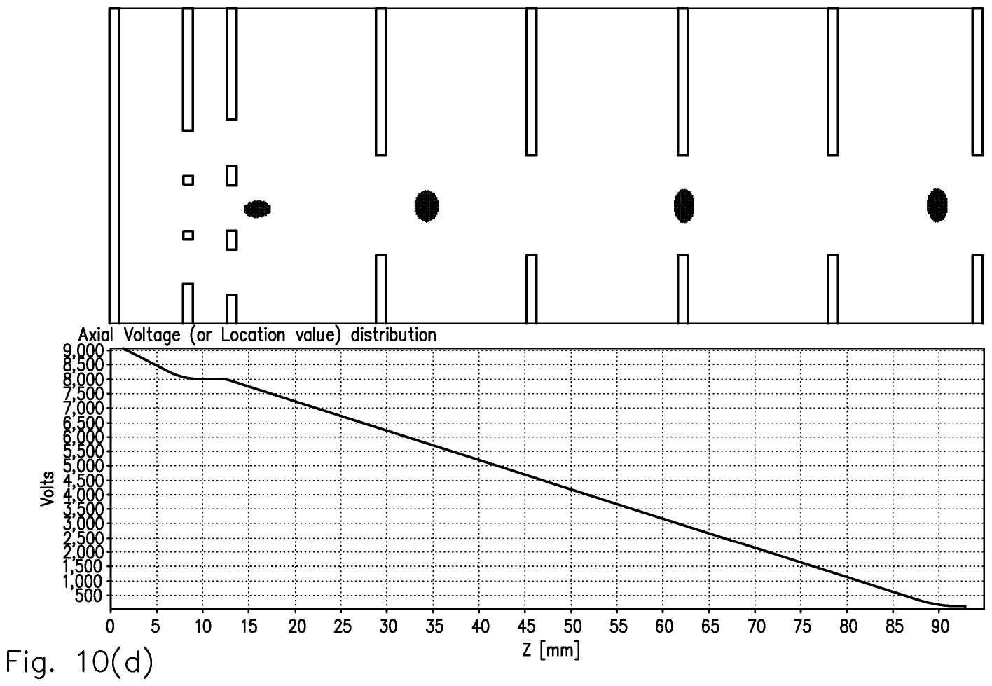

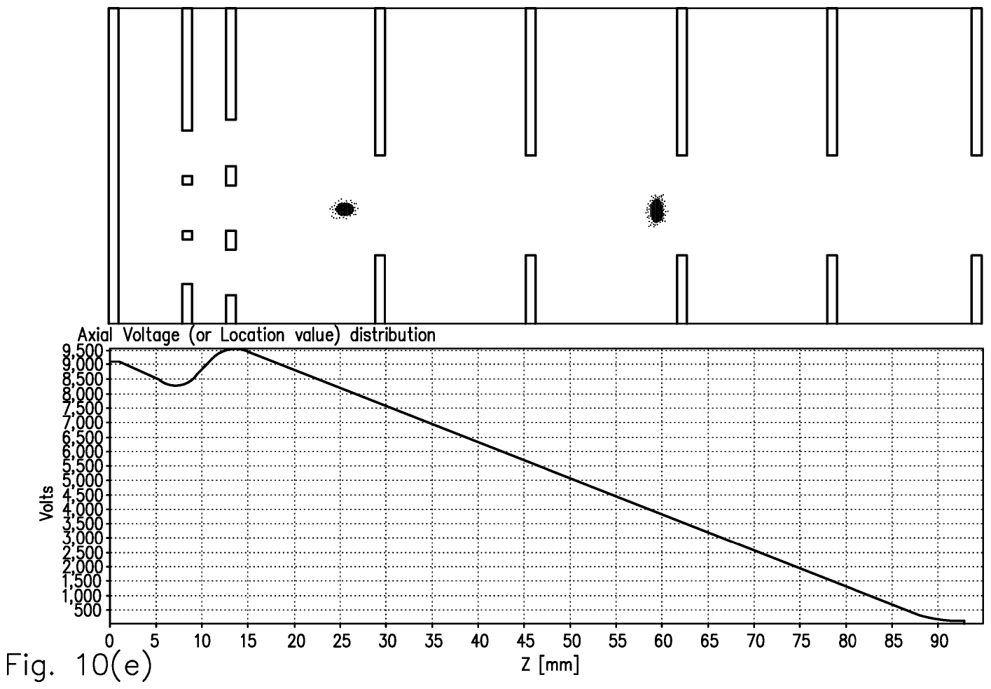

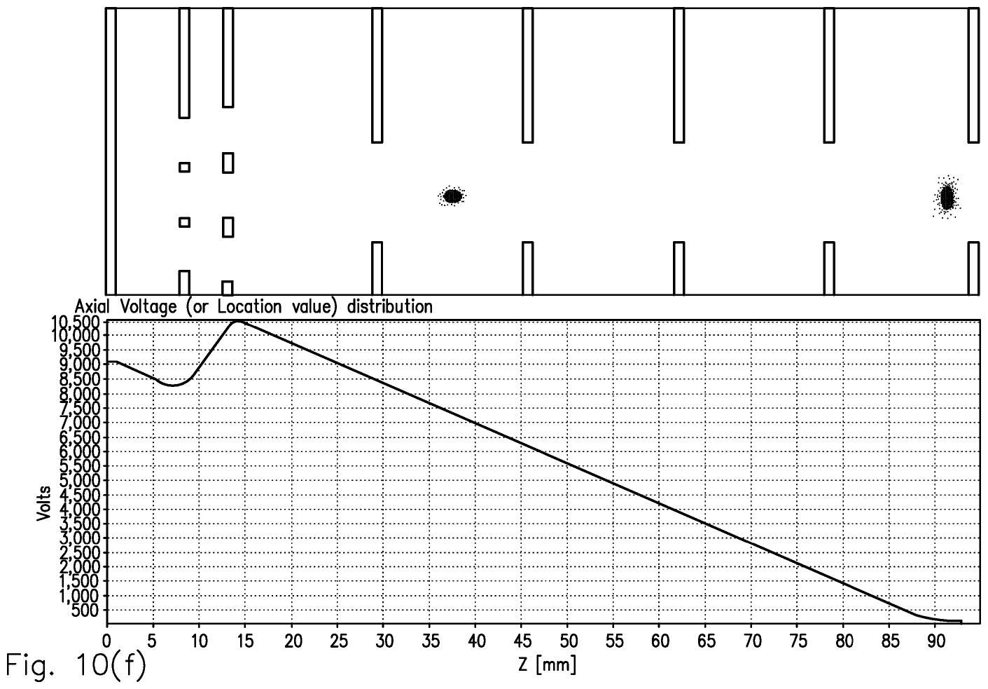

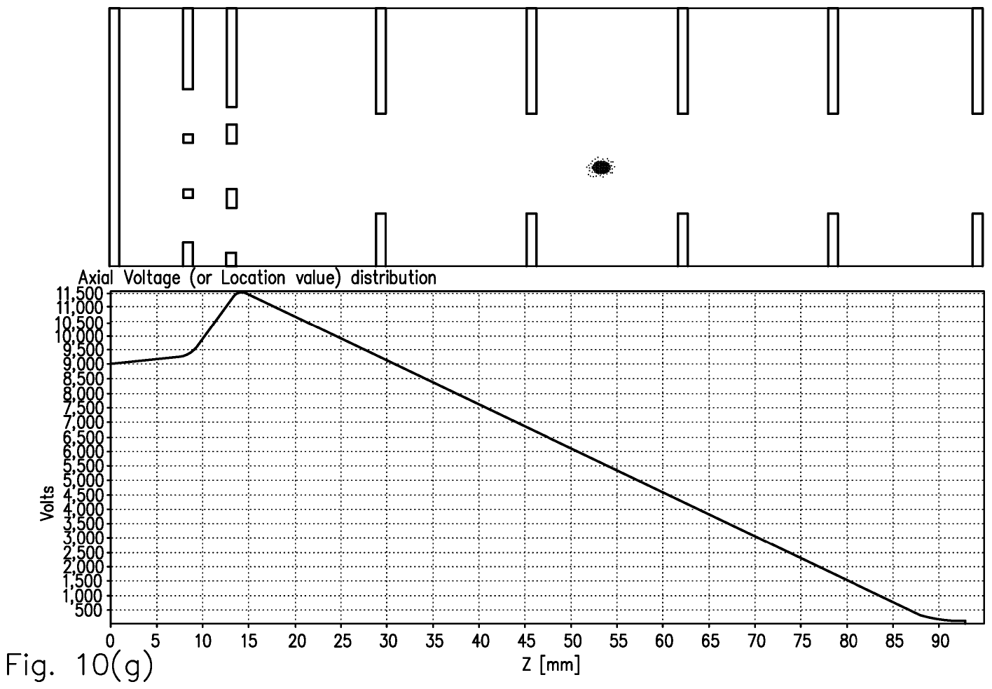

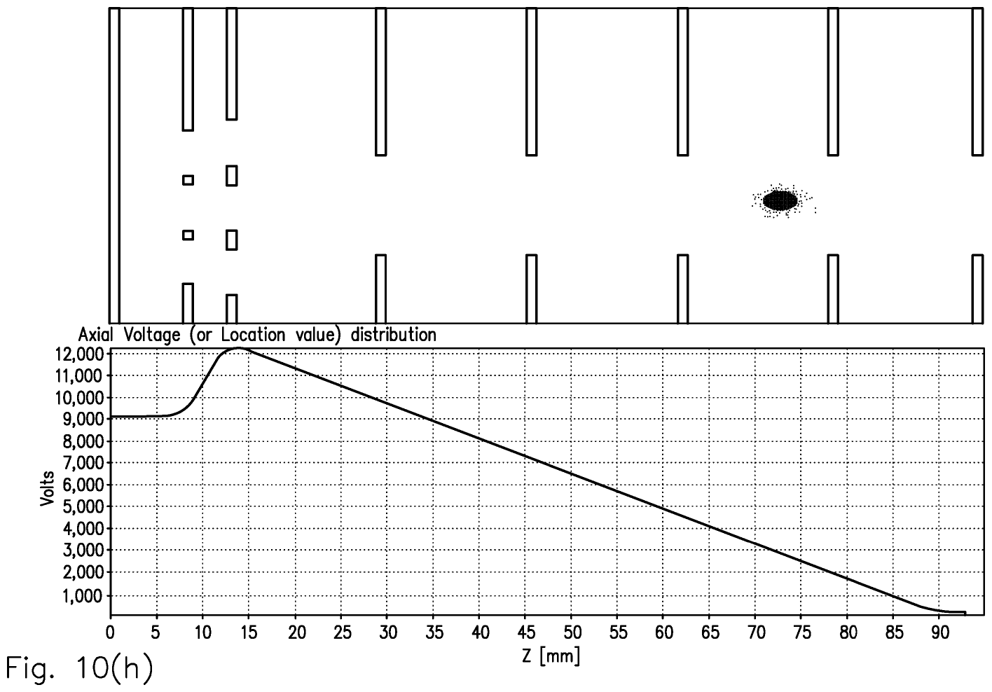

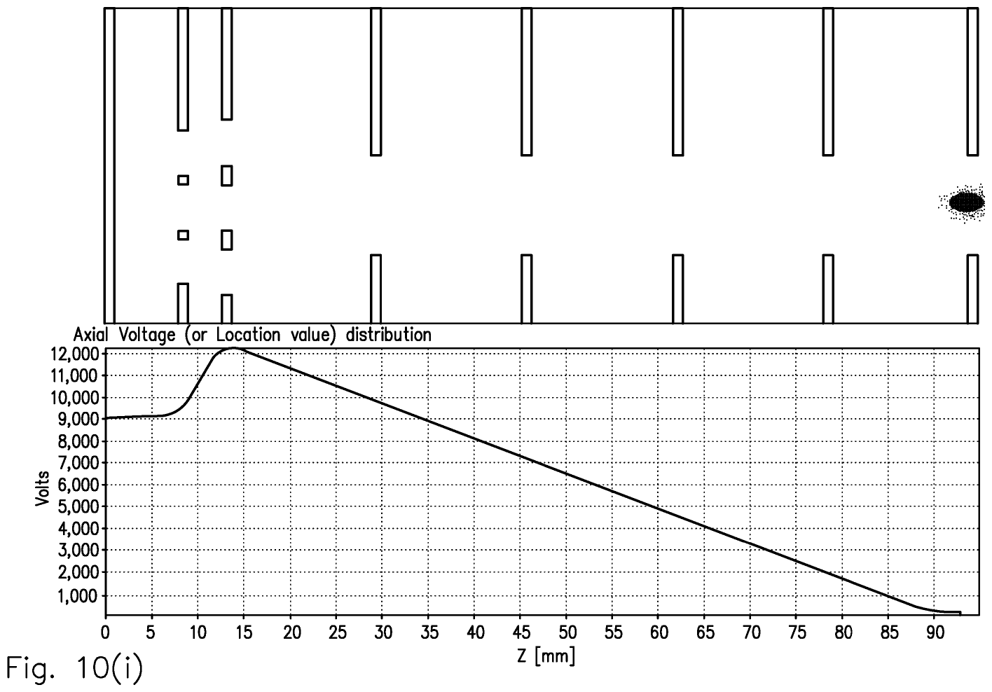

FIGS. 10(a) to 10(i) schematically depict a simulation of the TOF MS of FIG. 1(a), particularly showing expansion of 2 kDa, 3 kDa, 6 kDa and 17 kDa ions (in this example, into the first substantially field-free region and extraction of the ions therefrom). In this simulation, the time period t_{delay}=t_{extraction}−t₀, prior to the application of the extraction potential V_{extraction}, is 800 ns and the extraction pulse duration is 10 μs. The acceleration potential V_{acceleration} is applied from a time tₒₙ of 6.3 μs.

FIG. 10(a) schematically depicts the TOF MS of FIG. 1(a). For convenience, the first acceleration region, the feel free gap and the second acceleration region may be delimited thus: First acceleration region: extraction region between sample plate 101 and extraction plate 103 (entrance to field free gap)

Field free gap: region between first and second acceleration regions (i.e. between extraction plate 103 and first ramp electrode 105)

Second acceleration region: ‘dynamic ramp’ acceleration region from first ramp electrode 105 (exit of field free gap) to ground electrode 107 (entrance to TOF analyser).

FIGS. 10(b) to 10(i) each schematically depict the TOF MS of FIG. 1(a), including the ions, (above) and the corresponding axial potential (below). For convenience, the parameters are described as shown in Table 1. The applied potentials corresponding to FIGS. 10(b) to 10(i) are summarised in Table 2.

TABLE 1
Definitions, as defined previously

| Parameter | Description |
|---|---|
| t | time |
| t₀ | time zero, when ions desorbed from sample |
| t_{extraction} | time extraction pulse applied to accelerate |
| | ions across first acceleration region (~800 ns) |
| t_{extraction}_{_{—}}_{duration} | duration extraction pulse is applied across |
| | first acceleration region (>6 μs) |
| tₒₙ | time ‘dynamic ramp’ across second |
| | acceleration region starts (6.3 μs) |
| t_{off} | time ‘dynamic ramp’ across second |
| | acceleration region ends (16.3 μs) |

TABLE 1
Applied potentials as a function of time

| | | Sample | | Ramp | | |
|---|---|---|---|---|---|---|
| | | plate | Extraction | bias | | |
| | | 101 | plate 103 | 105 | Extraction | |
| FIG. | Time t | (V) | (V) | (V) | pulse | Comment |
| 10(b) | t₀ < t < t_{extraction} = | 9,000 | 9,000 | 8,000 | off | Field free |
| | 800 ns | | | | | across first |
| | | | | | | acceleration |
| | | | | | | stage |
| 10(c) | 800 ns = t_{extraction} < | 9,000 | 8,000 | 8,000 | on | Extraction |
| | t < tₒₙ | | | | | pulse applied |
| 10(d) | t = tₒₙ = 6.3 μs | 9,000 | 8,000 | 8,000 | on | Start of time |
| | | | | | | varying |
| | | | | | | acceleration |
| | | | | | | across second |
| | | | | | | acceleration |
| | | | | | | stage |
| 10(e) | t = tₒₙ + 2 μs | 9,000 | 8,000 | 9,500 | on | Step through |
| | | | | | | time varying |
| | | | | | | acceleration |
| | | | | | | across second |
| | | | | | | acceleration |
| | | | | | | stage |
| 10(f) | t = tₒₙ + 4 μs | 9,000 | 8,000 | 10,500 | on | Step through |
| 10(g) | t = tₒₙ + 6 μs | 9,000 | 9,000 | 11,500 | off | Step through |
| 10(h) | t = tₒₙ + 8 μs | 9,000 | 9,000 | 12,000 | off | Step through |
| 10(i) | t = t_{off} | 9,000 | 9,000 | 12,500 | off | End of time |
| | = tₒₙ + 10 μs | | | | | varying |
| | = 16.3 μs | | | | | acceleration |
| | | | | | | across second |
| | | | | | | acceleration |
| | | | | | | stage |

In more detail, FIG. 10(b) shows a condition before the extraction pulse is applied i.e. t₀<t<t_{extraction}=800 ns, where the ions can expand in the first few mm into what is a substantially field free region (i.e. the first substantially field free region) between the sample plate 101 and the extraction plate 103, which are both at the same potential of 9,000 V. The field beyond the extraction plate 103 is effectively immaterial due to the first substantially field free region.

In more detail, FIG. 10(c) shows a condition immediately after the extraction pulse is applied i.e. 800 ns=t_{extraction}<t<tₒₙ and the ions are accelerated by the extraction field across the first acceleration region, without any distortion from the field in second acceleration region due to the presence of the field free gap (the second substantially field region) therebetween. Here, the ions are accelerated through the first acceleration region by the application of the extraction pulse (−1,000 V for 10 μs) across this region—this is to achieve velocity focusing (slower ions gain more energy than faster ions of same m/z). Particularly, the potential applied to the sample plate 101 remains 9,000 V while the extraction plate 103 and the first electrode 105 are both at the same potential of 8,000V. Thus, there is a potential gradient across the first acceleration stage and a substantially feel free gap between the first acceleration stage and the second acceleration stage. Importantly, this field free gap prevents axial penetration of the field from the second acceleration region into the first acceleration region during pulse extraction. It should be understood that the field free gap is only field free when the extraction pulse is on i.e. t_{extraction}≤t<t_{extraction}+t_{extraction_duration} and before the dynamic ramp starts across the second acceleration region i.e. t<tₒₙ. The ‘axial potential plot’ clearly demonstrates the effectiveness of this field free gap. The important point is that the field in the first region is maintained until the highest m/z (17 kDa) ions have passed beyond its influence, here at a time >6 μs, as shown in FIG. 10(d). Note that while the extraction pulse is applied (i.e. the extraction potential V_{extraction}) in FIG. 10(c), the acceleration potential V_{acceleration}, across the second region, has not yet been applied.

In more detail, FIG. 10(d) shows a condition when the dynamic ramp across the second acceleration stage is first applied at t=tₒₙ. Here, the ions of the whole mass range of interest are within the second acceleration region. The relatively larger 17 kDa ions are just after the entrance to the second acceleration region i.e. the first ramp electrode 105 (exit of field free gap) while the relatively lighter 2 kDa ions are just before the exit of the second acceleration region i.e. the ground electrode 107 (entrance to TOF analyser). Particularly, the potential applied to the sample plate 101 remains 9,000 V while the extraction plate 103 and the first electrode 105 are both at the same potential of 8,000V. Thus, there is a potential gradient across the first acceleration stage and a substantially feel free gap between the first acceleration stage and the second acceleration stage. The field free gap is maintained, which now prevents any field penetration from first acceleration region into second acceleration region whilst some of the ions (e.g. the 17 kDa ions) are still close to the entrance to the second acceleration region. The dynamic ramp will now be changed across this second acceleration region, as shown in FIGS. 10(e) to 10 (i).

In this example, this is probably the earliest time when the extraction potential V_{extraction} would be switched off since the largest m/z ions have passed beyond its influence. Essentially, the extraction pulse is preferably ‘on’ to maintain the field free gap between the first two acceleration stages. FIG. 10(d) shows that not only does the second substantially field free region prevent the field in the second acceleration region distorting the field in the first acceleration region, but it also prevents the field in the first acceleration region from distorting that in the second acceleration region.

In more detail, FIG. 10(e) shows a condition after the dynamic ramp across the second acceleration stage has been applied at t=tₒₙ+2 μs, whilst the extraction pulse is still also being applied. Particularly, the potential applied to the sample plate 101 remains 9,000 V, the potential applied to the extraction plate 103 remains 8,000 V but the potential applied to the first electrode 105 is changed to 9,500V. Thus, there the potential gradient across the second acceleration region is increased. The relatively lighted 2 kDa and 3 kDa ions have exited the second acceleration region while the relatively heavier 6 kDa and 17 kDa ions are accelerated therethrough.

In more detail, FIG. 10(f) shows a condition after the dynamic ramp across the second acceleration stage has been applied at t=tₒₙ+4 μs, whilst the extraction pulse is still also being applied. Particularly, the potential applied to the sample plate 101 remains 9,000 V, the potential applied to the extraction plate 103 remains 8,000 V but the potential applied to the first electrode 105 is changed further to 10,500V. Thus, there the potential gradient across the second acceleration region is further increased. The 6 kDa ions are near the exit of the second acceleration region while the relatively heavier 17 kDa ions are further accelerated therethrough. In more detail, FIG. 10(g) shows a condition after the dynamic ramp across the second acceleration stage has been applied at t=tₒₙ+6 μs, when the extraction pulse is no longer applied. Particularly, the potential applied to the sample plate 101 remains 9,000 V, the potential applied to the extraction plate 103 is now 9,000 V (since the extraction pulse is no longer applied) but the potential applied to the first electrode 105 is changed still further to 11,500V. Thus, there the potential gradient across the second acceleration region is still further increased. The relatively heavier 17 kDa ions are still further accelerated therethrough. Changes to the field in the first acceleration region at this time are clearly not going to have any effect on the higher m/z 17 kDa ions in second acceleration region.

In more detail, FIG. 10(h) shows a condition after the dynamic ramp across the second acceleration stage has been applied at t=tₒₙ+8 μs, when the extraction pulse is also no longer applied. Particularly, the potential applied to the sample plate 101 remains 9,000 V, the potential applied to the extraction plate 103 remains 9,000 V but the potential applied to the first electrode 105 is changed even still further to 12,000V. Thus, there the potential gradient across the second acceleration region is even still further increased. The relatively heavier 17 kDa ions are even still further accelerated therethrough.

In more detail, FIG. 10(i) shows a condition just before the dynamic ramp across the second acceleration stage is no longer applied at t=tₒₙ+10 μs=t_{off}, when the extraction pulse is also no longer applied. Particularly, the potential applied to the sample plate 101 remains 9,000 V, the potential applied to the extraction plate 103 remains 9,000 V but the potential applied to the first electrode 105 is changed yet even still further to 12,500V. Thus, there the potential gradient across the second acceleration region is yet even still further increased. The relatively heavier 17 kDa ions are yet even still further accelerated therethrough and are exiting the second acceleration region.

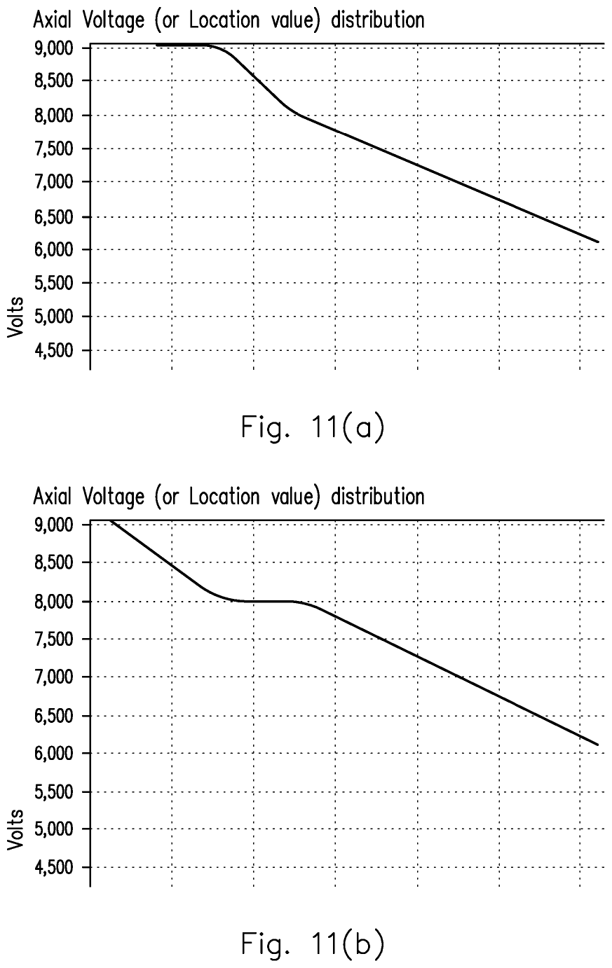

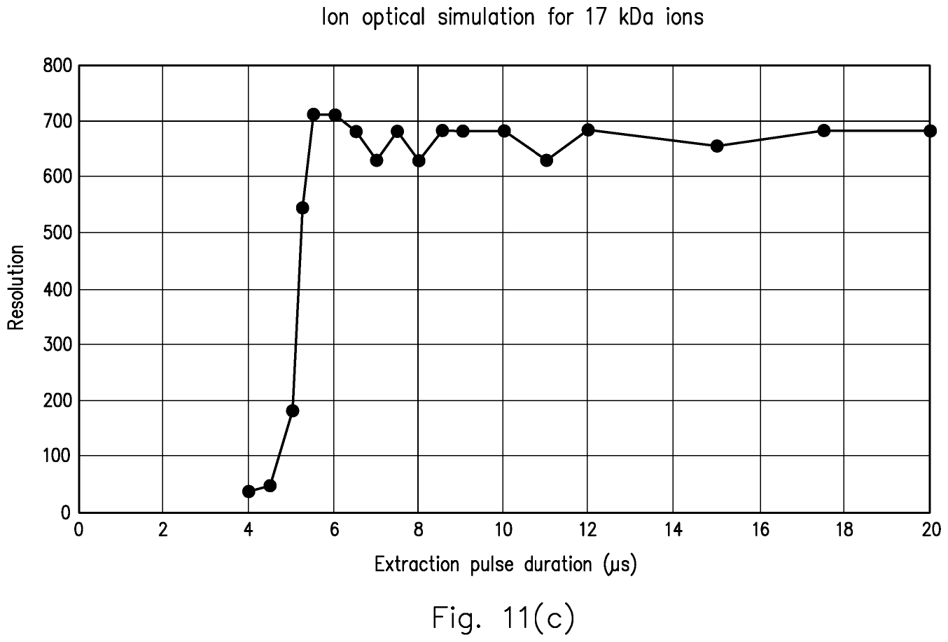

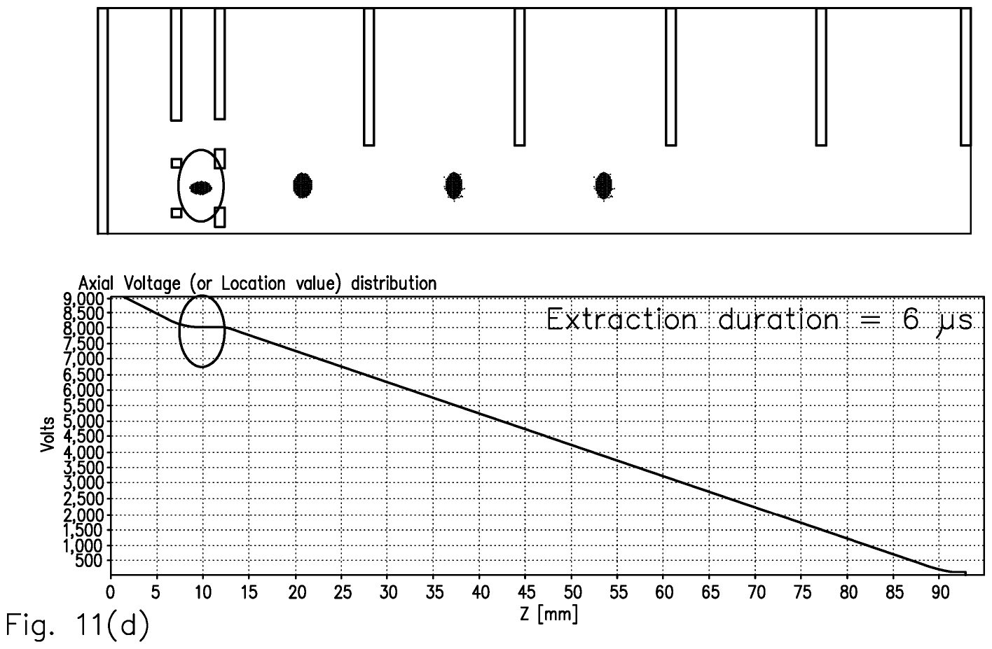

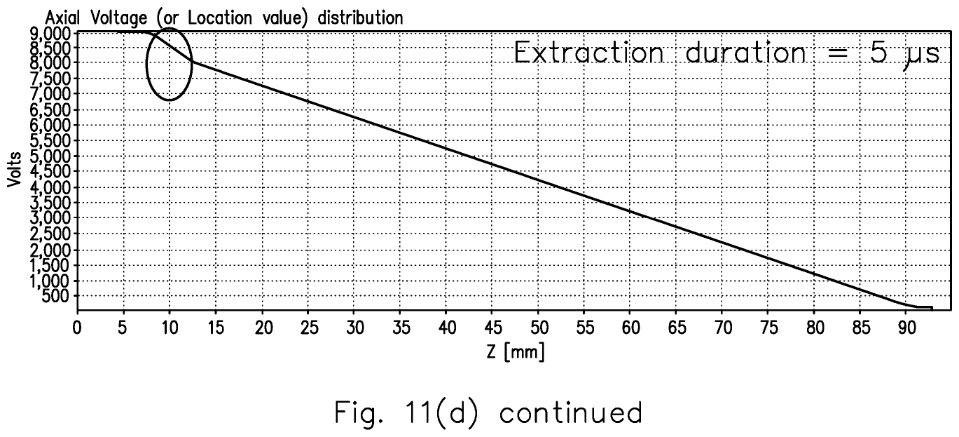

FIGS. 11(a) to 11(d) shows the simulation of FIGS. 10(a) to 10(i), in more detail.

In this example, the extraction delay (t_{extraction}) is a variable for tuning purposes, but typically ˜800 ns.

In this example, the ‘Dynamic ramp’ tₒₙ and t_{off} times, 6.3 μs and 16.3 μs respectively, are fixed values determined by design of the MS.

At time t₀<t<t_{extraction}, a field free region (FIG. 11(a)) exists between the sample and extraction electrode (the first acceleration region). The ion plume expands into this space until t=t_{extraction}.

At t=t_{extraction}, the extraction pulse is applied to the extraction electrode, dropping the potential on this electrode from 9000 V to 8000 V; thus creating a potential difference of 1000V across the first acceleration region (FIG. 11(b)) (i.e. between sample plate and extraction electrode). This ‘delayed extraction’ enables velocity focusing, which may be optimised for a given m/z (determined by actual value of t_{extraction}.).

The extraction pulse should remain ‘on’ for the whole time any ions of interest are still in the first acceleration region. If the extraction pulse is switched ‘off’ then the first acceleration region will revert to field free (FIG. 11(a)) state and velocity focusing will be lost for any remaining ions in the first acceleration region.

So, when can the extraction pulse be switched ‘off’? The quick answer is when the highest m/z ions of interest have passed from the first acceleration region, through the field free gap and into the second acceleration region. However, we also need to be aware that a modification to the field in the first acceleration region may affect the field in the second acceleration region, so we might want to wait a little longer.

Whilst the extraction pulse is ‘on’, we have a field free region between the two acceleration stages that minimises any influence the field in the first acceleration might have on the field in the second acceleration region.

The best way to determine the earliest time the extraction can be switched ‘off’ is by plotting the resolution of the highest m/z ions (17 kDa) against extraction duration (FIG. 11(c)).

FIG. 11(d) shows the extraction can be switch ‘off’ anytime after 6 μs i.e. after the ions have passes beyond the entrance to second acceleration stage.

The resolution plot below shows the minimum extraction duration to be ˜6 μs. A duration of 5 μs, for example, would be too short and the mass resolution would be degraded.

For illustration, two potential plots are shown, both at time t=6 μs, but with different extraction durations of 5 μs and 6 μs. The location of the highest m/z ions (17 kDa) at time t=6 μs is marked in each case. Clearly the fields at this location are different, for the two extraction durations, giving rise to the difference in resolution shown in the plot.

An extraction duration of 6 μs is a minimum value in this example, extraction durations longer than this (e.g. 10 μs or 100 μs) will not degrade the resolution since all the ions of interest will have passed into the second acceleration stage, or beyond, by the time the extraction is switched ‘off’.

Pulsed extraction duration is not generally a tuning variable. However, it needs to be set such that all ions of interest experience the required acceleration as per the design.

Turning ‘off’ the extraction potential too soon will compromise the velocity focusing and thus the resolution of the higher m/z ions.

Thus, there is a minimum extraction potential, for the instrument discussed here −6 μs, but there is no specific maximum value, for example 10 μs and 100 μs would be equally effective as 6 μs in this case.

Essentially, in this case, extraction duration=>6 μs. 6 μs could be used, as could 10 μs and 100 μs. Sometimes a larger value, such as 100 μs, might be chosen to move any electrical noise, associated with switching ‘off’ the extraction potential, outside the time-of-flight range of the analyser. However, the extraction duration must be <<repetition period for the instrument e.g. for an instrument running at 1 kHz the extraction duration must be <<1 ms to ensure the pulser electronics re-stabilise before next pulse triggered.

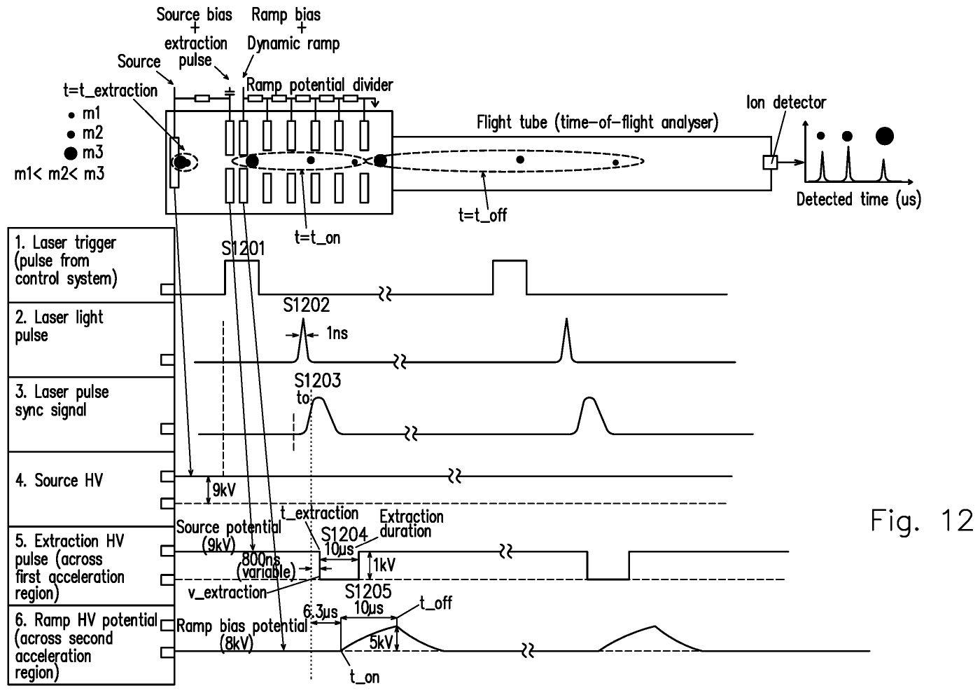

FIG. 12 schematically depicts a method of controlling a TOF MS according to an exemplary embodiment, in more detail.

At S1201, the controller provides a laser trigger pulse.

At S1202, a laser light pulse is emitted, ablating and ionising the sample, in response to the laser trigger pulse, as described with respect to S901. The laser light pulse typically has a peak width of about 1 ns (FWHM). The sample plate 101 is maintained at a constant potential of 9 kV.

At S1203, a laser pulse synchronisation signal is provided by a photodiode illuminated by a fraction of the laser light pulse, that defines the time t₀, which occurs at a fixed time after the laser light pulse.

At S1204, the extraction potential V_{extraction} is applied to the extraction plate 103 at a time t_{extraction}>t₀ i.e. after the time delay t_{delay}=t_{extraction}−t₀, which is about 800 ns in this example, as described with respect to S902. The extraction potential V_{extraction} is a square wave of amplitude −1 kV and a duration t_{extraction_duration} of 10 μs, superimposed on the otherwise constant potential of 9 kV applied to the extraction plate 103.

At S1205, the acceleration potential V_{acceleration} applied to the first electrode 105 during the time period Δt=t_{off}−tₒₙ is varied, as described with respect to S903. The time period Δt is 10 μs and tₒₙ−t₀ is 6.3 μs. The maximum amplitude of the acceleration potential V_{acceleration} is +5 kV, superimposed on the otherwise constant potential of 8 kV applied to the first electrode 105. At S1206 (not shown), the ions are detected, as described with respect to S904.

Steps S1201 to S1206 are repeated, for example at a frequency of 1 kHz.

### Alternatives

Although a preferred embodiment has been shown and described, it will be appreciated by those skilled in the art that various changes and modifications might be made without departing from the scope of the invention, as defined in the appended claims and as described above.

### Summary

In summary, the invention provides a novel ion optical acceleration scheme to enhance time-focusing over an extended m/z range. The inventors have arrived at several advantages of the proposed ion optical scheme over prior art acceleration configurations largely by decoupling the first ‘pulsed extraction’ acceleration stage 102 from the second time-dependent acceleration stage 106:
Electric field penetration of the second accelerating stage 106 into the first pulsed extraction stage 102 to eliminate prompt acceleration of ions and distortion of phase space during the time-delay and prior to the application of the extraction pulse is accomplished by introducing a short intermediate field-free gap 104. Elimination of the prompt acceleration effect allows for a more precise correlation between initial ion position and initial velocity to be established at the onset of the extraction voltage pulse, which has a strong effect on mass resolving power.
The short intermediate field-free gap 104 also allows for using electrodes with increased size apertures, enhancing transmission of heavier ions with considerably wider initial kinetic energy spreads, while also minimizing the amount of material deposited on critical surfaces, especially those in the desorption-ionization region, extending the operational lifetime of the system.
More importantly, the short intermediate field-free gap 104 created between two consecutive electrodes decouples the application of the extraction voltage pulse and the application of the high voltage ramp, which would otherwise complicate the analogue electronics design considerably. The extraction pulse is applied to the entrance electrode of the field-free gap 103 while the voltage ramp is applied independently to the electrode defining the exit end of the field-free gap 105 while both signals can be produced with high integrity and stability.

### Attention

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A time-of-flight, TOF, mass spectrometer, MS, comprising:
an ion source for supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, at a time t₀;
a first set of electrodes, including a first electrode, and a second set of electrodes, including a first electrode and an Nth electrode, wherein the first set of electrodes and the second set of electrodes are mutually spaced apart by a gap therebetween;
an ion detector for detecting the ions;
a set of power supplies, including a first power supply, electrically coupled to the first set of electrodes and to the second set of electrodes; and
a controller configured to control the set of power supplies to apply respective potentials to the first set of electrodes and the second set of electrodes;
wherein the controller is configured to control the set of power supplies to:
provide a first substantially field-free region between the ion source and the first set of electrodes to allow the group of ions to expand theretowards and/or therein, at the time t₀;
apply an extraction potential V_{extraction} to the first set of electrodes at a time t_{extraction}>t₀, to extract the expanded group of ions, while maintaining a second substantially field-free region beyond the first set of electrodes, in the gap between the first set of electrodes and the second set of electrodes; and
change an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios.

2. The TOF MS according to claim 1, wherein the controller is configured to control the set of power supplies to provide the first substantially field-free region between the ion source and the first set of electrodes by applying a static voltage V_{B} to the first set of electrodes.

3. The TOF MS according to any previous claim, wherein the controller is configured to control the set of power supplies to provide the first substantially field-free region between the ion source and the first set of electrodes for a time period t_{delay}=t_{extraction}−t₀.

4. The TOF MS according to any previous claim, wherein the controller is configured to control the set of power supplies to provide a substantially linear field in the second set of electrodes while providing the first substantially field-free region between the ion source and the first set of electrodes.

5. The TOF MS according to any previous claim, wherein the controller is configured to control the set of power supplies to maintain the second substantially field-free region beyond the first set of electrodes, in the gap between the first set of electrodes and the second set of electrodes, to at most 1% of the extraction potential V_{extraction}/mm.

6. The TOF MS according to any previous claim, wherein a length of the gap between the first set of electrodes and the second set of electrodes is at least a diameter of an ion aperture in the first set of electrodes or the second set of electrodes.

7. The TOF MS according to any previous claim, wherein the controller is configured to control the set of power supplies to change a magnitude of the acceleration potential V_{acceleration} applied to the second set of electrodes monotonically during the time period Δt=t_{off}−tₒₙ.

8. The TOF MS according to any previous claim, wherein the controller is configured to control the set of power supplies to quasi-linearly or linearly change the acceleration potential V_{acceleration} applied to the second set of electrodes during the time period Δt=t_{off}−tₒₙ.

9. The TOF MS according to any previous claim, wherein the first set of electrodes consists of the first electrode.

10. The TOF MS according to any previous claim, wherein the set of power supplies includes the first power supply electrically coupled to the first set of electrodes and a second power supply electrically coupled to the second set of electrodes.

11. A method of controlling a time-of-flight, TOF, mass spectrometer, MS, the method comprising:
supplying a group of ions, including a first ion having a first mass-to-charge ratio m₁/z₁, a second ion having a second mass-to-charge ratio m₂/z₂ and a third ion having a third mass-to-charge ratio m₃/z₃ wherein m₃/z₃>m₂/z₂>m₁/z₁, from an ion source at a time t₀ and allowing the group of ions to expand towards and/or into a first substantially field-free region between the ion source and a first set of electrodes, including a first electrode;
applying an extraction potential V_{extraction} to the first set of electrodes at a time t_{extraction}>t₀, to extract the expanded group of ions, while maintaining a second substantially field-free region beyond the first set of electrodes, in a gap between the first set of electrodes and a second set of electrodes, including a first electrode and an Nth electrode, wherein the first set of electrodes and the second set of electrodes are mutually spaced apart by the gap;
changing an acceleration potential V_{acceleration} applied to the second set of electrodes during a time period Δt=t_{off}−tₒₙ, wherein tₒₙ>t_{extraction}, to vary acceleration of the extracted group of ions based, at least in part, on respective mass-to-charge ratios; and
detecting the ions.

12. The method according to claim 11, comprising providing the first substantially field-free region between the ion source and the first set of electrodes by applying a static voltage V_{B} to the first set of electrodes.

13. The method according to any of claims 11 to 12, comprising providing the first substantially field-free region between the ion source and the first set of electrodes during a time period t_{delay}=t_{extraction}−t₀.

14. The method according to any of claims 11 to 13, comprising providing a substantially linear field in the second set of electrodes while providing the first substantially field-free region between the ion source and the first set of electrodes.

15. The method according to any of claims 11 to 14, wherein maintaining the second substantially field-free region beyond the first set of electrodes, in the gap between the first set of electrodes and the second set of electrodes, comprises maintaining the second substantially field-free region beyond the first set of electrodes, in the gap between the first set of electrodes and the second set of electrodes, to at most 1% of the extraction potential V_{extraction}/mm.

16. The method according to any of claims 11 to 15, wherein a length of the gap between the first set of electrodes and the second set of electrodes is at least a diameter of an ion aperture in the first set of electrodes or the second set of electrodes.

17. The method according to any of claims 11 to 16, wherein changing the acceleration potential V_{acceleration} applied to the second set of electrodes during the time period Δt=t_{off}−tₒₙ comprises changing a magnitude of the acceleration potential V_{acceleration} applied to the second set of electrodes monotonically during the time period Δt=t_{off}−tₒₙ.

18. The method according to any of claims 11 to 17, wherein changing the acceleration potential V_{acceleration} applied to the second set of electrodes during the time period Δt=t_{off}−tₒₙ comprises quasi-linearly or linearly changing the acceleration potential V_{acceleration} applied to the second set of electrodes during the time period Δt=t_{off}−tₒₙ.

19. The method according to any of claims 11 to 18, wherein the first set of electrodes consists of the first electrode.

20. The method according to any of claims 11 to 19, comprising independently applying respective voltages to the first set of electrodes and to the second set of electrodes.

21. A computer comprising a processor and a memory configured to implement, at least in part, a method according to any of claims 11 to 20, a computer program comprising instructions which, when executed by a computer comprising a processor and a memory, cause the computer to perform, at least in part, a method according to any of claims 11 to 20 or a non-transient computer-readable storage medium comprising instructions which, when executed by a computer comprising a processor and a memory, cause the computer to perform, at least in part, a method according to any of claims 11 to 20.
